(19) United States
(12) Patent Application Publication
(10) Pub. No.: US 2013/0167731 A1
(43) Pub. Date: Jul. 4, 2013

(54) ATTACHMENT FOR A TEA KETTLE

(71) Applicants: Ruedi Eidenbenz, Triesen (CH); Chi Ming Tse, Hong Kong (CN); Enrico Dalla Piazza, Schneisingen (CH)

(72) Inventors: Ruedi Eidenbenz, Triesen (CH); Chi Ming Tse, Hong Kong (CN); Enrico Dalla Piazza, Schneisingen (CH)

(73) Assignee: Enrico DALLA PIAZZA, Schneisingen (CH)

(21) Appl. No.: 13/814,468

(22) PCT Filed: Aug. 6, 2010
(86) PCT No.: PCT/CH10/00194

§ 371 Date: Feb. 21, 2013

(51) Int. Cl. A47J 31/52

(52) U.S. Cl. CPC A47J 31/52
USPC 99/283

(57) ABSTRACT

An attachment for a container for the preparation of an extraction beverage comprises a base plate mounted horizontally on the container, having an aperture for an extraction product container to pass through, and a lifting apparatus which comprises a sleeve. The lifting apparatus has a guide fixed to the base plate for guiding the sleeve in a direction perpendicular to the base plate. The lower position defines a brewing position of the sleeve and the upper position defines an inoperative position. A locking apparatus locks the sleeve in the brewing position. A timer is also provided for operating the locking apparatus so that after a predefinable time period the sleeve is unlocked when it is locked in the brewing position. The sleeve is acted on by a restoring force to move from the brewing position to the inoperative position when the sleeve is unlocked.

### TECHNICAL FIELD

The invention relates to an attachment for a solvent container for the time-controlled preparation of an extraction beverage, in particular for brewing tea, comprising a base plate for placing onto an opening of the solvent container, wherein the base plate has an aperture for the passage of an extraction product container, and there is a lifting device which comprises a sleeve on which the extraction product container is mounted in such a manner that it projects beyond the sleeve at a lower end and can be filled with an extraction product through an upper opening of the sleeve, wherein the lifting device has a guide device which is fixed on the base plate and on which the sleeve is guided displaceably in a direction substantially perpendicular to the base plate with the effect of a linear guide between a lower and an upper position, wherein the lower position defines a brewing position of the sleeve, in which the extraction product container is lowered, and the upper position defines an inoperative position in which the extraction product container is raised in relation to the brewing position, and the lifting device has a locking device for locking the sleeve in the brewing position, and there is a timer which is designed in such a manner for actuating the locking device that, after a predefinable period of time has elapsed; the sleeve is unlocked when it is locked in the brewing position. Furthermore, the invention relates to a tea kettle with such an attachment, wherein the timer comprises an actuating element for setting a period of time.

### PRIOR ART

US 2006/0288873 A1 (Yang Heng-Te) refers to a device for the time-controlled preparation of tea, with which the tea herb can be separated from the tea after a predetermined time. For this purpose, the device comprises a main body which, in a state placed on a solvent container, comprises a timer at the top, with which a period of time can be set by means of a rotation about a vertical axis. At the same time as the period of time is set, in particular in a first actuating section of the timer, a tea container which is arranged under the main body is guided downward and is locked in this position. After the period of time has elapsed, the tea container is unlocked, whereupon the tea container is moved upward by a lifting device. In this case, the mechanism of the lifting device makes it necessary for the tea container, for filling purposes, to have to be unscrewed from a filter cover, which is connected fixedly to the lifting device, for which purpose the device has to be removed from the solvent container. As a result, the filled tea container is screwed again onto the filter cover, whereupon the device can be placed again onto the solvent container. The handling of the device is therefore awkward, since the filling of the tea container necessitates the removal of the device from the solvent container. In addition, the screwing of the tea container to the filter cover is frequently difficult to bring about and is susceptible to soiling by means of tea herb penetrating the thread.

DE 198 39 421 A1 (Gerber Jens Joerg) concerns a small strainer, the strainer insert of which is pulled telescopically after a time which can be set on the strainer cover into a closed strainer container by a mechanical or electric drive. The strainer insert is moved upward and downward by a screw sleeve with an internal screw thread and a screw bolt of the strainer container. The strainer container is fillable with the tea herb from above through the strainer cover while the small strainer is placed onto a solvent container. Although DE 198 39 421 A1 (Gerber Jens Joerg) provides a tea strainer which is easy to fill, it has a comparatively complicated construction for the lifting device because of the helical groove. In addition, due to large friction losses in the screw sleeve, a powerful and therefore costly spring mechanism has to be provided. Not least, the screw sleeve is susceptible to soiling with tea herb, as a result of which the device can be blocked and therefore possibly does not function reliably.

### SUMMARY OF THE INVENTION

It is therefore the object of the invention to provide an attachment, which belongs to the technical field mentioned at the beginning, for a solvent container for the time-controlled preparation of an extraction beverage, which attachment is cost-effective and robust while being able to be handled in a simple manner.

The achievement of the object is defined by the features of claim 1. According to the invention, the attachment for a solvent container for the time-controlled preparation of an extraction beverage, in particular for brewing tea, has a base plate for placing onto an opening of the solvent container, wherein the base plate has an aperture for the passage of an extraction product container. Furthermore, there is a lifting device which comprises a sleeve on which the extraction product container is mounted in such a manner that it projects beyond the sleeve at a lower end and can be filled with an extraction product through an upper opening of the sleeve. In this case, the lifting device comprises a guide device which is fixed on the base plate and on which the sleeve is guided displaceably in a direction substantially perpendicular to the base plate with the effect of a linear guide between a lower and an upper position, wherein the lower position defines a brewing position of the sleeve, in which the extraction product container is lowered, and the upper position defines an inoperative position in which the extraction product container is raised in relation to the brewing position. Furthermore, the lifting device comprises a locking device for locking the sleeve in the brewing position. In addition, there is a timer which is designed in such a manner for actuating the locking device that, after a predefineable period of time has elapsed, the sleeve is unlocked when it is locked in the brewing position. According to the invention, the sleeve is acted upon along the linear guide in the brewing position by a restoring force which resets the sleeve from the brewing position into the inoperative position when the sleeve is unlocked.

The base plate is provided for placing onto the solvent container. The solvent container is customarily arranged during the preparation on a horizontal base so that the solvent remains in the container. An upper supporting edge of the solvent container, which supporting edge bounds the opening on which the attachment is placed, is therefore generally likewise arranged substantially horizontally, and therefore the base plate is also typically arranged horizontally. Of course, the base plate can also be placed onto a solvent container which is located on a sloping plane. Within the context of the base plate arrangement which is therefore horizontal within the widest meaning on the solvent container, reference is made below by means of the relative terms, such as “at the bottom” and “at the top” to an arrangement of the attachment in a horizontal arrangement ready for operation on a solvent container. In this context, the term “perpendicular” likewise refers to the substantially horizontally arranged base plate and is therefore substantially synonymous with “direction perpendicular to the base plate.” or “axially”, unless stated otherwise. In this case, a direction from the top downwards is defined by the direction of gravity.

The base plate may, in principle, have largely any shape which, however, permits placing onto the opening of the solvent container. In this case, in a state placed on the solvent container, one side of the base plate faces the solvent container. As a rule, the base plate is of substantially planar design and, over substantially the entire circumference of the opening, rests on the supporting edge of the solvent container. The attachment parts which are described below are preferably arranged on a base plate side which is opposite the container side.

The base plate preferably has an encircling wall with a radially projecting edge for supporting the attachment on the supporting edge of the solvent container. The attachment is therefore held in a particularly stable manner on the solvent container. If the projecting edge is arranged higher than the base plate, the base plate is arranged in a manner lowered into the interior space of the solvent container, and therefore the center of gravity of the attachment is kept low and hence a better support is achieved. The projecting edge can additionally also serve as an installation surface for a covering (see further below). However, the base plate can also be formed without a special edge and can rest from above on the supporting edge of the solvent container. In this case, downwardly projecting stops are preferably provided, the stops preventing a radial displacement of the attachment with respect to the solvent container.

The attachment may be provided with, for example, a clip fastening or other fastening means in order to fix the attachment on the solvent container. Finally, the attachment may also be connected in the manner of a tea kettle cover to the solvent container in an articulated manner. The size of the attachment is preferably matched to a solvent container provided therefor. In one variant embodiment, however, the attachment may also be designed in such a manner that different solvent containers, in particular jugs, cups, etc., can be used. For this purpose, for example, a conical wall can be provided on the circumference of the base plate, said wall permitting the attachment to be plugged onto different openings.

The aperture in the base plate is preferably located in the plane of the plate and provides a passage in the axial direction, i.e. direction perpendicular to the base plate. The lifting device is preferably arranged at the aperture in a manner fixed on the base plate, wherein the sleeve is arranged aligned with the aperture so as to be displaceable in a direction substantially perpendicular to the base plate. The lifting device therefore permits raising or lowering of the extraction product container, which is mounted on the sleeve, through the aperture in a direction substantially perpendicular to the base plate. For this purpose, the aperture is dimensioned in such a manner that the extraction product container and optionally the sleeve can be displaced unhindered through the aperture. In particular, the aperture has a circumference which substantially corresponds to the circumference of the extraction container or of the sleeve. The extraction product container and optionally the sleeve can therefore pass through the aperture in the axial direction without there being a substantial distance circumferentially between the extraction product container or sleeve and the circumference of the aperture.

The sleeve is designed to be open at both longitudinal ends, preferably in the shape of a cylinder, in particular as a straight circular cylinder, the longitudinal axis of which is arranged coaxially with a base plate perpendicular, preferably with a mean perpendicular of the base plate, wherein, in this case, a center point of the aperture is likewise arranged centrally with respect to the base plate.

The extraction product container is mounted on the sleeve in such a manner that it projects, for example telescopically, through a lower of the openings of the sleeve. The extraction product container is open at the top such that, in a state mounted on the sleeve, said extraction product container can be filled with an extraction product, such as, for example, tea herb, through the upper opening. The extraction product container can therefore be conveniently filled with tea herb while the attachment is placed on the solvent container.

According to the invention, the lifting device for axial lifting and lowering comprises a guide device which is fixed on the base plate and on which the sleeve is guided displaceably in a direction substantially perpendicular to the base plate with the effect of a rectilinear linear guide between a lower and an upper position. In this case, the guide device may comprise, for example, rails or rods which are fixed on the base plate, are arranged perpendicularly to the base plate and on which runners of the sleeve are guided displaceably. The guide device may also comprise a guide sleeve which is fixed on the base plate and in which the sleeve of the lifting device is guided displaceably in a telescopic manner.

The displacement distance of the sleeve in the guide device is preferably defined by two stops. In an operationally ready state of the attachment in which the latter is placed onto a solvent container, an upper stop of the guide device defines an inoperative position of the sleeve and a lower stop defines a brewing position. If the entire guide device is arranged on that side of the base plate which faces away from the solvent container, the lower stop is arranged in the vicinity of the base plate and the upper stop is arranged remote from the base plate. In the inoperative position, the sleeve is displaced in the guide device as far as the upper stop, and therefore the extraction product container which is mounted on the sleeve is raised with respect to the base plate through the aperture. In the brewing position, the sleeve is displaced as far as the lower stop such that the extraction product container is lowered into the interior space of the solvent container through the aperture.

The locking device of the lifting device is designed in such a manner that the sleeve, when it is passed into the brewing position, is preferably automatically locked in this position. The timer is designed and interacts with the locking device in such a manner that, after a predefineable period of time has elapsed, said timer can actuate the locking, as a result of which the sleeve is unlocked. In this case, the timer may be arranged fixed on the base plate or placed onto the sleeve, for example as a cover, or integrated into the sleeve.

According to the invention, the sleeve is acted upon along the linear guide in the brewing position by a restoring force. In this manner, upon unlocking of the sleeve by the timer after the predefineable period of time has elapsed, the extraction product container which is mounted on the sleeve can be automatically brought or lifted out of the interior space of the solvent container in a simple manner. In particular, the linear guide permits as direct an action of the restoring force as possible, as a result of which, firstly, the lifting movement can be brought about in a simple manner. Secondly, a comparatively small restoring force is sufficient, since only a rectilinear action has to be applied without substantial friction losses, as occur in the case of sloping or helical guides. The sleeve is preferably acted upon by the restoring force over the entire displacement distance. When the sleeve is lowered from the inoperative position into the brewing position counter to the restoring force, the actuating energy can therefore be temporarily stored and removed for a restoring operation. Owing to the rectilinear guide, the actuating energy is optimally used in this case and, at the maximum effective lifting distance, can also be used likewise optimally again for the restoring operation. By the lifting device also comprising a sleeve on which the extraction product container is mounted, as described above, an attachment for a solvent container, which attachment is simple to fill in any position and has a simple and robust construction is therefore produced.

The restoring force is preferably provided by an elastic element which acts between the base plate and the sleeve. The elastic element preferably comprises a spring, in particular a spiral spring, preferably a spiral compression spring. A particularly simple and cost-effective realization of the restoring force is therefore achieved. Of course, the elastic element can also be designed in a different manner, for example as a rubber band, tension spring, leg spring or the like. A spring can be arranged laterally or in an encircling manner with respect to the sleeve. In the case of a lateral arrangement of the sleeve, more than one, in particular at least two symmetrically arranged springs are preferably provided, thus making it possible to prevent tilting of the sleeve. The attachment preferably comprises a spring guide for the spring, wherein one element of the guide is connected fixedly to the sleeve and a further element is connected fixedly to the base plate. The spring guide is preferably formed on the guide device or has a separate linear guide. The sleeve or the base plate preferably comprises an axially oriented pin which is at least partially introduced into the interior space defined by the spring. The base plate or the sleeve preferably comprises a spring guiding sleeve into which the spring can be at least partially introduced. A robust guidance of the spring is therefore ensured; in particular, buckling of the spring can therefore be prevented. However, the spring guiding sleeve may also be omitted.

The restoring force could also be provided by means of a counterweight, in particular in the form of a lever guide.

The extraction product container is preferably insertable into the sleeve and comprises a flange as a stop on one side in an upper region. The extraction product container can therefore be grasped particularly readily by a user and can be removed by hand from the sleeve. The extraction product container can likewise be introduced into the sleeve from above by the user in a very simple manner. This permits simple use of the attachment and in particular fits in well with users, the motor capabilities of whom are reduced, since, for example, the extraction product container does not have to be screwed in or fastened in another complicated manner. The extraction product container preferably has a slightly larger diameter in the region of the flange than the sleeve, and therefore the extraction product container can be grasped particularly readily. Furthermore, the outside of the flange can comprise radially encircling flutes, thus making it possible to prevent slipping upon grasping. Optionally, it may also be sufficient if only part of the flange projects radially beyond the sleeve. The extraction container is essentially designed as a circular cylinder which is closed on one side and, in a lower region, in the base surface and/or circumferentially, comprises holes through which the solvent can flow in and out. In this case, it is advantageous if the extraction product container has holes both at the bottom and also laterally such that, even as said extraction product container is immersed into the solvent, the latter can readily flow through the interior space of the extraction product container. The extraction container is preferably held in the sleeve in a manner secured against rotation. This may be achieved, for example, by means of radially outwardly projecting knobs arranged on the circumference of the extraction product container, in particular below the flange, and corresponding inward notches in the upper region of the sleeve. Of course, knobs and recesses may also be interchanged.

The stop may also be realized, for example, by means of a tongue and groove guide, wherein the groove has a lower stop. The means for securing against rotation between the extraction product container and sleeve could therefore be realized at the same time.

The extraction product container preferably comprises a strainer part and a holding part, wherein the strainer part is latchable coaxially in the holding part in a plurality of axial positions. In this case, the abovementioned stop is formed on the holding part which is therefore inserted into the sleeve in a longitudinal position defined by the stop. Since the extraction product container is latchable in the holding part in various longitudinal positions, an immersion depth of the extraction product container can therefore be adapted depending on the filling height in the solvent container. In particular, the attachment can therefore also be used for solvent containers of different dimensions. The latching can be achieved, for example, by means of latching lugs and recesses.

The extraction product container may also be designed such that it can be screwed into the sleeve, and therefore the axial positions can be reached by means of a rotation, wherein the position is fixed in the axial direction by means of a frictional connection or latching lugs. However, the holding part and the strainer part may also be designed as a single-piece insert.

The extraction product container is preferably lowered from above through the aperture during a transfer from the inoperative position into the brewing position of the sleeve. In this case, the components of the lifting device are preferably arranged substantially on a base plate side which faces away from the solvent container. In this case, the extraction product container is inserted into the sleeve from above, and therefore, when the sleeve is lowered into the brewing position, said extraction product container passes through the aperture into the interior space of the solvent container when the attachment is placed onto a solvent container. The handling of the attachment is therefore simplified further, since, when the attachment is placed on the solvent container, the extraction product container can be both filled and lowered without the attachment having to be removed from the solvent container.

The extraction product container is preferably lowerable directly by a user counter to the restoring force from the inoperative position into the brewing position where the sleeve is automatically locked. For this purpose, the user exerts a force oriented substantially in the axial direction on the extraction product container and thus guides same downward counter to the restoring force, which is realized, for example, by means of a spring (see above). However, the sleeve may also be lowered into the brewing position indirectly, for example via an additional actuating lever.

Since the extraction product container is mounted on the sleeve, said extraction product container is guided downward with the sleeve, whereupon the locking device locks the sleeve, and therefore also the extraction product container, in the brewing position. With the actuation by the user, the actuating energy which is applied in order to overcome the restoring force and which is required later on for raising the extraction product container after the period of time has elapsed is preferably stored at the same time in an energy accumulator. In this case, the energy accumulator is provided by the elastic element, for example a spring, which applies the restoring force. The energy accumulator therefore stores the actuating energy and permits removal of the latter in order to raise the sleeve.

In the attachment, all of the structural elements of the lifting device are preferably arranged outside the sleeve with respect to the axial direction. The tea herb can therefore be placed unhindered through the sleeve into the extraction container without any structural parts of the lifting device obstructing the filling. During the filling of the extraction product container through the sleeve, it is therefore also not possible for the tea herb to come into contact with the lifting device and, for example, soil or, in the worst case scenario, block or damage the lifting device. Therefore, the lifting device can preferably be accommodated entirely within a hollow body, which is present where applicable (see below), of the attachment, and can preferably be arranged substantially encapsulated in the attachment, and therefore the lifting device is also protected from general soiling, such as dust, etc., and optionally against splashed water. In addition, the lifting device can thereby be protected against incorrect handling or manipulation and is therefore robust and can be designed in a space-saving manner.

The guide device preferably comprises a guide sleeve which is present at the aperture on the base plate and on which the sleeve is guided displaceably, wherein an interior space of the guide sleeve communicates with the aperture of the base plate and, in the inoperative position, preferably at least partially receives the extraction product container. By means of such a guide sleeve, tilting of the sleeve can be substantially suppressed and an optimally controlled longitudinal guidance ensured. The guide sleeve is preferably formed as a single piece with the base plate, but may also be connected to the base plate in another manner. The sleeve is preferably guided on the guide sleeve in a manner secured against rotation. This may be achieved, for example, by means of a rod and a slider. The rod can be connected to the base plate in an axially oriented manner, preferably outside the sleeve, wherein the sleeve comprises, as a slider, projections which project radially outward in the lower region and have guide openings, wherein the rod can be guided in said openings. The restoring force can therefore be realized at the same time by a helical compression spring being arranged around the rod. Of course, the rod may also be connected to the sleeve and the slider to the base plate. Furthermore, the guide sleeve may also comprise, for example, a guide groove and the sleeve may also comprise a correspondingly shaped lug or vice versa. Furthermore, the guide sleeve and the sleeve may have a shape which is not circular cylindrical but is rather, for example, designed in each case as a cylinder with a polygonal or oval area, wherein the guide sleeve and the extraction container have corresponding shapes. A means of securing the sleeve against rotation in relation to the guide sleeve may therefore be achieved at the same time. Instead of the guide sleeve, it is also possible only for other guide means to be provided. For example, guide pins, guide rails and/or partially circular cylindrical barrels can be provided.

The sleeve preferably, forms a substantially round connecting pipe. The extraction product container can therefore be introduced in a simple manner into the sleeve. This is because the round design of the sleeve ensures as great a degree of freedom as possible with respect to axial rotation of the extraction product container on introduction of the latter into the sleeve.

The sleeve is preferably of double-walled design, wherein an intermediate space between the double wall is downwardly open and is upwardly substantially closed. The sleeve is preferably arranged pulled over the guide sleeve in such a manner that, at least in the brewing position, the guide sleeve is located in the intermediate space between the double wall. The restoring force can thereby act on the outer wall while the extraction product container is received via the inner wall and the upper edge. A particularly simple transmission of the restoring force between the base plate and the sleeve is therefore achieved. The axial height of the guide sleeve is preferably somewhat higher than the lifting distance of the lifting device, and therefore guidance of the sleeve is ensured in every longitudinal position along the guide. However, the sleeve does not necessarily have to be designed to be double-walled in an encircling manner. The double wall, for example, may only be provided in regions, or the sleeve has only one inner wall and is guided telescopically in the guide sleeve.

The guide device preferably comprises guide rails or guide rods which are fixed on the base plate, are arranged perpendicular to the base plate and on which the sleeve is guided in a sliding manner by outwardly projecting flange-like projections arranged in a manner fixed on the sleeve. A more robust sleeve guide is therefore achieved by itself or in addition to the guide sleeve.

The locking device preferably has an actuating element which is designed and arranged in such a manner that it can interact with the timer, in particular in the brewing position of the sleeve. For this purpose, the locking device preferably comprises an element which is connected to the base plate and a further element which is connected to the sleeve, which preferably intermesh in order to lock the sleeve. At least one of the elements is preferably designed as an actuating element or is provided with an actuating element and is mounted in a movable and/or resilient manner. The elements are designed and arranged in such a manner that, in the locked state, they block a displacement of the sleeve in the longitudinal guide at least in one direction.

The locking device preferably has a first latching hook which is anchored on the base plate, is in particular mounted pivotably and is arranged in such a manner that it latches to a latching element of the sleeve when the sleeve is in the brewing position, wherein the latching element of the sleeve preferably comprises a second latching hook which is in particular connected fixedly to the sleeve and is preferably integrally formed thereon, wherein the actuating element in particular comprises a lever arm which is connected to the first latching hook. A particularly simple locking device is therefore provided. The first latching hook is preferably mounted in a peripheral region of the sleeve so as to be pivotable radially with respect thereto. In the region of the pivot axis, in particular above the pivot axis, the first latching hook comprises a latching lug which is oriented substantially horizontally and which is arranged outside the sleeve even when the sleeve is lowered. The first latching hook is connected to the actuating element which is designed as an elongate section which is oriented substantially axially. The actuating element is preferably offset radially inward with respect to the first latching hook such that the latter, when the sleeve is lowered, comes to lie at least partially between the two walls of the sleeve, when the latter is of double-walled design. The actuating element therefore protrudes axially upwards from the pivot axis. At the lower edge of the outer wall, the sleeve comprises a radially outwardly protruding second latching hook which is oriented tangentially to the sleeve and horizontally and is placed circumferentially in such a manner that, in the lowered state, it can interact with the first latching hook and, in particular, can lock the sleeve in the lowered state. If the actuating element is pivoted in said locked state, the sleeve is unlocked and is moved upward by means of the restoring force. The sleeve may also have a projection or a recess into which a latching hook mounted pivotably on the base plate via a tangential axis can engage. A person skilled in the art also knows other possibilities as to how such a locking device can be provided.

The first latching hook is preferably acted upon with a restoring force in such a manner that the latching element of the sleeve automatically latches to the latching hook when the sleeve passes into the brewing position. The first latching hook is held by means of a restoring force in an inoperative position which corresponds to an engagement position in the locked state. The restoring force is preferably provided by means of a spring, in particular by means of a leg spring. Simple operation of the attachment is therefore made possible, since the locking automatically engages when the brewing position is reached. A person skilled in the art also knows further elastic elements which are likewise suitable for generating a restoring force (rubber band, tension spring, etc.).

The first and the second latching hook have a bevel acting as a control surface such that, upon contact of the latching hooks, the first, pivotable latching hook yields counter to the restoring force thereof and, when the brewing position is reached, the latching hooks snap into position. In order to unlock the sleeve, the actuating element is pivoted counter to the restoring force, and therefore the first latching hook, which is coupled to the actuating element, pivots out of the engagement position over the second latching hook and the engagement of the latching hooks is thus released.

The timer preferably has a triggering element which is moved substantially continuously during the countdown of the predefineable period of time and, after the predefineable period of time has elapsed, interacts with the actuating element of the locking device in such a manner that the sleeve is unlocked when it has been locked in the brewing position. The triggering element is designed in such a manner and is arranged in an operationally ready arrangement with respect to the actuating element of the locking device in such a manner that, when the predefineable period of time has elapsed, the triggering element can pivot the actuating element counter to the restoring force thereof, i.e. can actuate the locking device and can thus unlock the sleeve.

A substantially continuously moving triggering element permits a structurally simple design of the timer, since, for example, the movement of a minute spindle of a conventional clockwork can be transmitted directly to the triggering element. The actuation of the locking device after the predefineable period of time has elapsed therefore only takes place on the basis of a suitable relative arrangement of the actuating element of the locking device with respect to the movement path of the triggering element. However, it is not ruled out that the triggering element is moved only after the period of time has elapsed. Depending on the timer, the movement may also take place in discrete steps. In other variant embodiments, the actuating element may also be coupled fixedly, for example in an articulated manner, to the timer or to the triggering element.

The actuating element of the locking device preferably reaches up to an upper edge region of the sleeve when the sleeve is in the brewing position. This is advantageous in particular whenever the timer, preferably in the form of a removable cover, is designed so as to be placeable onto the upper opening of the extraction product container. Since the actuating element projects into the upper edge region of the sleeve, the timer can therefore interact directly in the upper edge region of the sleeve with the locking device in a simple manner. Further functional parts of the locking device can be formed at a distance from the timer in the region of the base plate where there is a comparatively large amount of space and good installation options. In addition, the effect achieved by an actuating element which is designed, for example, as an elongate lever and is mounted on the base plate is that the timer, or the triggering element, because of the lever action has to exert only a small force on the actuating element of the locking device in order to actuate the locking device. By means of the design of the timer as a removable cover, a particularly user-friendly construction is achieved, since the timer can be removed, for example, for cleaning of the attachment. The cover is preferably designed to be removable at any time, that is to say even during the brewing operation, when the predefineable period of time elapses, if, for example, extraction product has to be topped up. A timer of removable design furthermore gives rise to the possibility of being able to provide said timer as a replacement part without having to exchange the entire attachment in the event of damage.

The actuating element of the locking device, in particular in the brewing position, is preferably at least partially arranged in the intermediate space between the two walls of a sleeve of double-walled design, and therefore the actuating element is substantially encapsulated and is protected from incorrect handling and from soiling.

The triggering element of the timer is preferably designed as a rotatable element, in particular as a lever which is mounted rotatably about an axis of rotation. During the countdown of the period of time, the triggering element in this case rotates about the axis of rotation which, when the cover or timer is placed on, is preferably arranged axially, in particular coaxially, with respect to the extraction product container. The cover preferably comprises the actuating element of the timer for setting a desired duration, wherein, when the cover is placed on, the actuating element is preferably designed as a rotary switch oriented coaxially with the axis of rotation. The triggering element is arranged parallel in a lower region of the cover and projects radially beyond a lower diameter of the cover. The triggering element can be coupled directly to the movement of the rotary switch, or else can be stepped down or stepped up, for example via a gearing. The triggering element may also be designed as an element which is mounted in a rotating manner in a vertical plane, projects into the upper edge region of the sleeve and can thereby actuate the actuating element. However, the timer does not absolutely have to be designed as the cover but rather may also be arranged, for example fixedly, on the base plate. In this case, the actuating element does not project up to an upper edge region of the sleeve but rather expediently lies in the region of a movement path of the triggering element of the timer.

Preferably, the actuating element of the locking device reaches into a cutout in the upper edge region of the sleeve, in which cutout the triggering element of the timer is also arranged when the timer is placed onto the sleeve, wherein the cutout is in particular upwardly open such that the triggering element can be brought upward out of the cutout when the timer is removed from the sleeve. The movement path of the triggering element is advantageously limited to the region of the cutouts. In the brewing position of the sleeve, the actuating element of the locking device is preferably arranged in an azimuthal end region of the cutouts. The actuating element is therefore actuated by the triggering element only after the predefineable period of time has elapsed, i.e. at the end of the movement path. It goes without saying that the relative arrangement of the actuating element at the end of a movement path of the triggering element also provides a simple possibility in other arrangements of the locking device and of the timer for ensuring the actuation of the locking device only after the predefineable period of time has elapsed.

In the case of a double-walled design of the sleeve, the cutout is preferably formed only on an inner wall of the sleeve. In this case, a guide sleeve, which is present where applicable, of the guide device advantageously has a corresponding cutout which is arranged completely overlapping with the cutout of the sleeve when the sleeve is in the brewing position. The effect which is therefore achieved is that the triggering element of the timer can be arranged within the sleeve and the actuating element of the locking device can be arranged outside the guide sleeve and nevertheless the two elements can interact. In particular, the triggering element can project in the radial direction both beyond the inner wall of the sleeve and beyond the guide sleeve and can thus, in the movement path thereof, grasp the actuating element when the latter is arranged, for example, between the two walls of the sleeve of double-walled design. In this case, the actuating element is substantially protected against external interventions, and therefore a risk of damage to the locking device can be reduced. If the actuating element is arranged outside the outer sleeve wall, the cutout preferably also grasps the outer sleeve wall, and therefore the triggering element can reach through the cutout and can actuate the actuating element of the timer.

A side of the base plate, which side is provided for placing onto the solvent container, is preferably of substantially planar design, and the opposite side of the base plate is spanned by a dome, thus producing a hollow body between the base plate and the dome, in which hollow body the components of the longitudinal guide and of the lifting device are entirely or partially accommodated. The aperture of the base plate in particular continues through the dome such that the sleeve can emerge or projects upward out of the dome in the region of the displaceability provided by the longitudinal guide, in particular in the inoperative position. The dome-shaped covering of the mechanism of the attachment protects said mechanism against damage and provides the attachment with an aesthetically attractive shape. In addition, the dome shape has the advantage that water splashes readily run off and therefore it reduces soiling and the cleaning is simplified. Since, in the inoperative position, the sleeve protrudes over the dome, the extraction product container can be removed from above or filled with extraction product in a particularly simple manner when the attachment is placed onto a solvent container.

The effect also achieved by the excess length is that the sleeve serves as actuating element for the lowering of the extraction product container. A user simply presses the sleeve, with the cover possibly present, into the dome until the sleeve latches in the brewing position. It goes without saying that the covering does not need to be designed as a dome, but preferably has a convex, substantially rotationally symmetrical shape. If the sleeve is latched in the brewing position, the predefineable period of time can be set, for example, via the actuating element, which is designed as a rotary regulator, of the timer arranged in the cover. Owing to the restoring force, the sleeve is moved rectilinearly upward and is ready for re-actuation.

The locking device is preferably additionally actuable by a separate operating element with which locking of the sleeve can be released manually such that a brewing operation can be terminated prematurely by a user. The attachment is preferably substantially formed from plastic in order to permit hygienic cleaning. It goes without saying that the components of the timer or springs which are present where applicable may comprise metal. A multiplicity of suitable materials is familiar to a person skilled in the art for this purpose.

The invention also provides a tea kettle which comprises a solvent container and an attachment according to the above description. The attachment is in particular placed onto an opening of the solvent container such that, in the brewing position of the sleeve of the lifting device, the extraction product container is lowered into an interior space of the solvent container, said interior space being provided for a solvent, typically water, and therefore, with a regular filling amount of the solvent, the extraction product container is immersed into the solvent. In the inoperative position, the extraction product container is substantially brought out of the interior space. In this case, however, the extraction product container does not have to be brought completely out of the interior space but rather is preferably raised at least to a degree such that, in the event of a regular filling amount, the interior space of the extraction product container is no longer immersed into the solvent.

In a second aspect, the invention, also independently of the abovementioned embodiments, relates to a further attachment for a solvent container for the time-controlled preparation of an extraction beverage, in particular to a tea kettle for brewing tea. The device comprises a base plate for placing onto a solvent container, an extraction product container and a lifting device, which is attached to the base plate, for the extraction product container, wherein the lifting device is designed and is arranged with respect to the solvent container in such a manner that the lifting device can raise the extraction product container out of a state in which it is lowered into an interior space of the solvent container when the attachment is placed onto the solvent container, as provided. Furthermore, the second aspect has a locking device for locking and unlocking the lifting device in the lowered state of the extraction product container, and a timer which can interact with the locking device in such a manner that the lifting device is unlocked after a predefined period of time. In this case, the timer has an actuating element with an actuating direction for actuating the timer, wherein the timer also comprises a mechanical energy accumulator for storing an actuating energy applied to the actuating element, and, during the predefined period of time, the energy accumulator is discharged. In this case, the locking device comprises a first element and a second element, wherein, during the preparation of the extraction beverage, one of the two elements is arranged fixedly with respect to the solvent container and the other element is arranged fixedly with respect to the extraction product container, and the first and the second element are arranged interacting in such a manner that the first element is guided movably by the second element in a second actuating direction during the predefined period of time and, after the predefined period of time has elapsed, is guided movably in a first actuating direction.

A further approach to an attachment for the time-controlled preparation of an extraction beverage is therefore provided, which attachment is simple to operate and is cost-effective to produce.

According to the second aspect of the invention, the effect which is achieved is that, at the same time as the actuating element of the timer is actuated in the first actuating direction, the extraction product container can be lowered into the interior space of the solvent container and a first part of the energy accumulator can be charged. With a subsequent actuation of the actuating element of the timer in the second actuating direction, it is possible, as a result, for a further part of the energy accumulator to be charged and for a period of time to be set at the timer. In this case, the first actuating direction can be different from the second actuating direction, and therefore it is intuitively already clear to a user on the basis of the actuating direction whether, by the actuation of the actuating element of the timer, the user lowers the extraction product container or activates the timer and sets the latter for a period of time.

Furthermore, it is achieved according to the second aspect that the same actuating element of the timer can be actuated both for the lowering of the brewing product container and for the setting of the period of time. The construction and the operation of the device are therefore kept simple and clear.

In addition, the effect achieved by the guiding of the first element by the second element according to the second aspect is that the actuating element of the timer is actuated sequentially in both actuating directions, and therefore, when the extraction product container is lowered, a period of time cannot be inadvertently set at the same time, or vice versa. This facilitates a simple and at the same time reliable operation of the device in particular for users with less sensitive motor skills.

Conversely, as a result, sequential discharging of the two components of the energy accumulator is also made possible and a parallel discharging can be prevented. In particular, the two parts of the energy accumulator can store different amounts of energy, which can be accessed substantially independently. Preferably, part of the energy accumulator provides the energy for the lifting device and one part thereof provides the energy for the timer.

According to the second aspect, during the countdown of the period of time, the first part of the energy accumulator is also locked with the locking device. After the predefineable period of time has elapsed, the energy stored in the first part of the energy accumulator is released and supplied to the lifting device for lifting the extraction product container. The second part of the energy accumulator of the second aspect makes the energy available for the timer which removes the energy stored in the second energy accumulator in a controlled manner and uses said energy for measuring the period of time which is intended to elapse between the actuation of the timer and the raising of the extraction product container. Typically, less energy therefore has to be able to be stored in the second part of the energy accumulator than in the first part of the energy accumulator.

The extraction product container of the second aspect in an operationally ready arrangement of the attachment on the solvent container is preferably brought out of an interior space of the solvent container by the lifting device in such a manner that the extraction product container is preferably raised completely out of the solvent for the customary filling levels. The extraction beverage, in particular after the dripping down of the extraction product, therefore can no longer be further concentrated. In variant embodiments, a substantial portion of the extraction product container can be lifted out of the extraction beverage, and therefore the extraction beverage is only insubstantially further concentrated. However, the extraction product container of the second aspect can also be of telescopic design, and therefore an immersion depth of the extraction product container can be matched to a filling level of the solvent in the solvent container. For this purpose, the extraction product container can be pulled apart to at least two discrete lengths, or else continuously, to any length, and pushed together.

According to the second aspect, both the first and the second part of the energy accumulator are of mechanical design. An independency of external energy sources is therefore substantially achieved, apart from a possibly necessary heating of the solvent. This not only has the advantage that extraction beverages can therefore be prepared in the absence of external, for example electric, energy sources, but also that the attachment can be safely washed without, for example, having to expect an electric shock or damage to the device. Furthermore, a simple and cost-effective construction of the attachment is therefore made possible.

The mechanical energy accumulator of the second aspect preferably comprises a first spring which acts upon the actuating element of the timer counter to the first actuating direction with a spring force such that, when the actuating element of the timer is actuated in the first actuating direction, the first spring is tensioned. A cost-effective, simple and low-maintenance construction of energy accumulator is therefore achieved. In a particularly preferred embodiment, the spring is tensioned by, in particular rectilinear, pressurization, which enables operation by means of simple movements. The actuating direction is preferably rectilinear.

In a variant embodiment of the second aspect, the mechanical energy accumulator can also be of pneumatic design. For this purpose, for example, an interior space of a pressure container could be acted upon with positive or negative pressure by means of the actuating element of the timer, wherein, during the predefined period of time, pressure is removed from the container interior until the (approximate) ambient pressure is reached. However, such a construction is generally more complicated than the embodiment with springs, but may be a preferred embodiment depending on requirements.

The first spring of the energy accumulator of the second aspect is preferably designed as a helical spring. In this case, commercially available helical springs made from spring steel are particularly preferred, since said helical springs are commercially available cost-effectively in virtually any conceivable shape and with any spring constant. Helical springs, because of the geometry thereof, can also be integrated into a housing in a particularly simple and space-saving manner; in particular, a plurality of helical springs having the different diameter can be arranged lying one inside another (parallel connection), wherein a volume used up in such a manner corresponds at maximum to that of the largest spring. A helical spring is particularly advantageous when the first actuating direction is rectilinear. In this case, a helical spring does not absolutely have to be formed from spring steel but may also be manufactured from other alloys or, for example, also from plastic. A helical tension spring may also be used instead of the helical compression spring. A helical tension spring could be arranged, for example, such that an upper region of the helical tension spring is connected to an upper region of the attachment according to the second aspect in such a manner that an extraction product container can be introduced into said helical tension spring as far as a stop located at a lower end and can subsequently be tensioned by pressurization.

Similarly as in the case of the above-described helical tension spring, use may also be made of rubber bands which generally, however, have a shorter service life than helical springs. Furthermore, use may also be made of leaf springs, for example coiled up in the form of spiral springs. In principle, any other type of spring is also conceivable, such as, for example, conical springs, leg springs, disk springs and the like which may also be combined altogether as desired.

Preferably, the mechanical energy accumulator of the second aspect comprises a second spring which acts upon the actuating element of the timer in the second actuating direction with a spring force such that, when the actuating element of the timer is actuated in the second actuating direction, the second spring is tensioned.

In the case of the energy accumulator of the second aspect, which energy accumulator is charged by serial actuation in two actuating directions via an individual actuating element, it is advantageous to use separate springs for the first part and the second part of the energy accumulator. The charging and discharging of the energy accumulator in the two actuating directions can therefore be decoupled from each other in a simple manner and the actuating directions can therefore be selected independently of each other. In addition, different types of springs or at least springs having different spring constants, can therefore be used for the different actuating directions. The effect therefore furthermore achieved is that, depending on the actuating direction, a force which is to be applied can be set differently by the selection of the spring. For example, the first part of the energy accumulator of the second aspect can therefore be provided for an energetically more complicated action, such as, for example, the raising of the extraction product container, by means of a helical spring having a relatively large spring constant, the helical spring being tensioned by rectilinear pressing together. Secondly, for example, the second part of the energy accumulator of the second aspect for the timer can be designed as a smaller energy accumulator which can be charged, for example, by means of rotation of a rotary knob analogously to a classical egg timer counter to a spring having a smaller spring constant.

As a variant embodiment, in the second aspect of the invention, the same spring can be used for the two actuating directions, i.e. the spring is part of the first and of the second part of the energy accumulator. However, this is in general comparatively complicated to realize because of the different actuating directions, since spring forces of a spring element are generally dependent on one another in a tangential and in an axial direction.

The second spring of the energy accumulator of the second aspect is preferably designed as a torsion spring. The torsion spring here is advantageously geometrically designed substantially in the form of a helical spring, with a preferably negligibly small spring constant in the axial direction. The effect which is therefore achieved is that the first and the second spring in the device can have the same geometrical orientation, but different dynamic effects. As small a volume as possible in the construction is therefore achieved, since, for example, the helical springs have a smaller diameter than the torsion spring and therefore can be arranged, for example, coaxially within the torsion spring. The effect furthermore achieved by the use of the torsion spring is that the second actuating direction, at which the second part of the energy accumulator is charged, can be a rotational movement. In principle, however, a single spring may also be used simultaneously as a helical and torsion spring, and therefore costs and space can be saved, and the complexity of the construction simplified. In this case, the spring constant would not be negligibly small in the axial direction. Finally, other known types of torsion spring, such as, for example, spiral springs, may also be used.

The first element of the second aspect preferably comprises a cylindrical section and a projecting element while the second element is designed as a guide. The cylindrical section of the first element interacts with the second element, which is designed as a guide, in such a manner that the axial section is axially movable and at the same time rotatable. The first element can therefore be moved in any sequence in the first and the second actuating direction. In particular, as a result, a simultaneous, combined movement in the first and the second actuating direction is also made possible. By means of the projecting element of the first element and a corresponding guide on the second element, the permissible directions of movement of the first element can be defined. The possibility of arranging a plurality of such projecting elements each with a corresponding guide, with which a more stable guidance would be achieved, is therefore not ruled out.

In a particularly preferred embodiment of the second aspect, the projecting element is designed as a comb-like element, in particular as a journal, and the guide is designed as a linear guide or groove having, for example, a rectangular or trapezoidal cross section, or as a stop on one side or to differ in sections. Furthermore, in particular if a retention is desirable in certain positions, an adjustment spring construction can be provided. Depending on the direction of a dynamic effect on the first element, or if there is a further stop, the guide may also be formed only on one side. The guide preferably has a plurality of sections, in particular precisely two sections with respect to the two actuating directions. In this case, a first and a second of the two sections may have different guide directions, wherein one of the sections may also comprise a plurality of parallel guides. Owing to the plurality of guide sections, a plurality of functions can be controlled sequentially by the same actuating element. In this case, the first section is designed as a groove, in particular as a plurality of grooves arranged in parallel, and the second section is designed as a stop on at least one side.

In one variant embodiment, in order, with the guide, to achieve additional stability of the construction, an undercut guide having a correspondingly shaped journal, such as, for example, a dovetail-like guide, would also be conceivable. However, in such a construction, care has to be taken to ensure that the friction does not become too great; in particular, tilting of the guide has to be able to be substantially prevented.

The second element of the second aspect, which element is designed as a guide, preferably comprises a cylindrical section for guiding the first element in the first actuating direction and a stop, at least on one side, for guiding the first element in the second actuating direction. In this case, the cylindrical section of the first element is guided in a plurality of ways. Firstly, by means of the projecting element and the guide, in particular by means of a groove as described above, and; secondly, by means of the cylindrical section of the guide, which section interacts with the cylindrical section of the first element so as to fit therewith.

The cylindrical section of the guide and the cylindrical section of the first element permit a random helical displacement of the first element, wherein the projecting element permits guidance of the first element in a direction determined by the groove, in particular in a rectilinear or helical direction. The guide could also be realized by axially mounted pins. By means of the projecting element and the groove, the otherwise random helical guidance of the cylindrical section of the first element by the cylindrical section of the guide can therefore be partially restricted in particular restricted to a certain helical path. In variant embodiments, the two actuating directions can be guided by a cylindrical section or the two can be guided by a stop on at least one side.

The second element of the second aspect, which element is designed as a guide, preferably comprises at least one groove for guiding the projecting element of the first element in the first actuating direction. The at least one groove can be designed as a stop on one side. In variant embodiments, the grooves and the projecting element may also be omitted, and therefore the first element is guided in the first actuating direction exclusively by the cylindrical section of the guide.

Preferably, during the preparation of the extraction beverage, the projecting element of the second aspect is arranged fixedly with respect to the solvent container and the second element of the second aspect, which element is designed as a guide, is arranged fixedly with respect to the extraction product container. The permissible movements of the extraction product container are thereby restricted or defined in a simple manner. An arrangement of the projecting element in a manner fixed with respect to the extraction product container and an arrangement of the second element, which is designed as a guide, in a fixed manner with respect to the solvent container are also conceivable.

The first actuating direction according to the second aspect is preferably oriented at a right angle to the second actuating direction. With the first actuating direction of the actuating element, the extraction product container is dipped into the solvent and with the second actuating direction a period of time is set. By means of a right angled arrangement of the two actuating directions, the two different functions, namely the lowering of the extraction product container and the setting of the period of time, can therefore be optimally kept apart from each other. Furthermore, an actuation by means of a single actuating element is therefore made possible.

In variant embodiments, a different arrangement of the two movement directions with respect to each other is also conceivable. The two actuating directions may, for example, enclose an angle which is significantly greater or smaller than 90°; in particular, the two actuating directions can also be oriented antiparallel. Finally, an angle between the two actuating directions, which angle is not constant over an actuating region, would also be conceivable. For example, the first actuating direction could correspond to the lowering direction of the extraction product container, and the second actuating direction could be defined by a slide or a lever arm which, for example, is at an angle of 45° with respect to the lowering direction. An ergonomic operation of the device would therefore be made possible, in particular if the device according to the second aspect is operated at table height and, for example, by the user in a standing position. Furthermore, an in particular linear actuating direction which is pivoted with respect to the lowering direction would also be conceivable, which actuating direction could be designed, for example, in the form of a push button which is fitted above a handle of the solvent container for operation with the thumb. Finally, an actuating direction could also run helically or in a similar manner.

Preferably, the first actuating direction according to the second aspect is designed to be substantially rectilinear, in particular vertically rectilinear, and the second actuating direction is designed to be substantially in the form of a rotation, in particular a rotation about a vertical axis. For the lowering of the extraction product container, a greater force typically has to be applied than for the setting of the period of time, and therefore a rectilinear, first actuating direction is expedient. For setting a period of time, a rotational movement is preferred, since such actuations of a timer are known to the user, for example, from typical egg timers. These two directions of movement can be kept apart in a simple manner, resulting, in turn, in a simple operation of the attachment according to the second aspect. Finally, the timer also does not require much energy, and therefore the energy to be stored in the second part of the energy accumulator according to the second aspect can easily be provided by a less vigorous movement over a short distance.

In variant embodiments, the actuating directions can also be selected in a different manner, in particular as mentioned above. However, the first actuating direction could also be defined as a pivoting of a lever arm in a, for example, vertical plane while the second actuating direction is defined by a pivoting of same lever in a horizontal plane.

The projecting element of the first element of the second aspect is preferably connected to the actuating element of the second aspect. The number of moving parts and the complexity of the construction of the device are therefore kept low. In a further embodiment, the actuating element can also take on the function of the extraction product container at the same time (or vice versa), and therefore the projecting element is indirectly connected to the actuating element.

On the other hand, the projecting element may also be connected directly to the extraction product container. Finally, an arrangement of the projecting element on a further, separate element which is connected neither to the actuating element nor to the extraction product container is also conceivable.

The timer of the second aspect preferably comprises a mechanical catch. The latter can be based on known principles, such as, for example, on a mechanical clock escapement, a centrifugal force brake, a conventional braking device, damping device or the like.

However, the catch may also be of electrical design. For this purpose, for example, an electric generator brake could be used as the catch. A period of time could therefore be set via a resistance. Furthermore, a capacitor or an accumulator could also be charged, wherein the energy stored in this manner could be available, after the period of time has elapsed, for an acoustic or optical signal. For this purpose, the electric conductors and components would have to be well sealed against the ingress of water so that the device or the attachment can be safely cleaned. However, the construction would therefore be complicated and expensive.

In a preferred embodiment of the second aspect, the mechanical catch blocks the discharging of the second part of the energy accumulator, in particular relaxation of the second spring. The catch permits a controlled relaxation of the second spring, or of the timer spring, and therefore the countdown of the predefineable period of time. In a preferred embodiment, the resistance force of the mechanical catch is defined in such a manner that a maximum period of time approximately corresponds to double the average period of time to be set, and therefore, firstly, accuracy in the setting of the period of time remains ensured, but nevertheless the user requirements regarding the preferred periods of time are taken into consideration as far as possible. It is conceivable, for example, for certain extraction beverages to require a quarter of an hour drawing time while other extraction beverages are already prepared within minutes. Depending on the embodiment, the predefineable period of time can be set here continuously or discretely. This can be achieved, firstly, by the selection of the torsion spring of the second aspect, or of the timer spring, and, secondly, by the selection and/or setting of the catch.

In variant embodiments with regard to the above-described mechanical catch of the second aspect, a discharging of the first part of the energy accumulator, in particular a relaxing of the first spring, can be blocked by the catch or by a further mechanical catch. A damped raising of the extraction product container can therefore be achieved. Furthermore, a conventional mechanical winding-up mechanism, such as in the case of a simple egg timer, may also comprise both the second spring, or the timer spring, and the mechanical catch.

The mechanical catch of the second aspect of the invention preferably comprises a rotatable element which is arranged fixedly with respect to the solvent container during the preparation of the extraction beverage and has a braking device which interacts with a region which is fixed with respect to the extraction product container and thereby blocks a relaxation of the second spring. The rotatable element is preferably designed as a mounted, disk-shaped element and is arranged fixedly relative to the solvent container.

The braking device can be designed here in a known manner. For example, the mounting of the rotatable element with sliding friction can be acted upon such that rotation of the rotatable element is blocked. A particularly simple and cost-effective catch is therefore achieved. Furthermore, the brake may also be designed as a catch analogously to that of a clock, or as a centrifugal force brake.

In variant embodiments, the catch of the second aspect can be designed in a simple case as a friction brake with a brake pad which interacts with a surface of the extraction product container. A simple and at the same time cost-effective construction is therefore achieved. Finally, a pneumatic or hydraulic damping, similar to that of a spring damping in a vehicle, is also useable, wherein the damping interacts directly with the spring.

The mechanical catch according to the second aspect preferably comprises a gearwheel and a braking device. For this purpose, in the fixed region, the actuating element has cutouts or a profiling, in particular in the form of a rack profile. The gearwheel, the braking device and the cutouts are then arranged so as to interact in such a manner that they block a movement of the actuating element in the second actuating direction, in particular the relaxation of the second spring. Such a construction achieves a reliable transmission of force and therefore a related precise setting of the period of time. In this case, the blocking can be undertaken via a silicone mounting of a spindle of the gearwheel.

In variant embodiments, the mechanical catch of the second aspect comprises a disk-shaped element with an encircling edge which is in contact with the fixed region and has a relatively high coefficient of friction. In particular when the second spring having a large spring constant is used, sliding of the disk-shaped element on the fixed region, which would result in a falsification of the period of time set, is therefore prevented. A high degree of stiction between the encircling edge and the fixed region can be realized by the selection of suitable materials, such as, for example, rubber for the encircling edge and plastic for the fixed region. The effect therefore achieved is that the fixed region does not have to be specially processed, since rubber together with most plastics and metals, or alloys, forms a high degree of stiction.

The predefineable period of time of the second aspect is preferably settable via a deflection distance of the actuating element in the second actuating direction. A clear distinction can therefore be made between the lowering of the extraction product container and the setting of a period of time. However, in principle, setting of the period of time via a further, separate actuating element is also conceivable.

Preferably, the mechanical catch of the second aspect is designed so as to be bridgeable, in particular so as to be able to be switched off via a further actuating element. This is advantageous in particular if too large a period of time has been set, or the preparation of the extraction beverage is intended to be terminated prematurely for other reasons. In this case, the catch can be bridged with the further actuating element, and therefore the second spring, or the timer spring, is relaxed again and the predefined period of time stands at zero. This is preferably brought about by an interaction between the rotatable element and the catch being designed to be able to be interrupted. For this purpose, the mechanical catch is mounted by means of the further actuating element on a spindle so as to be displaceable axially, counter to a spring force, in such a manner that, in the event of actuation of the further actuating element failing, the gearwheel interacts with the rack profile, and therefore the relaxation of the second spring, or the timer spring, remains blocked and, when the further actuating element is actuated, the gearwheel does not interact with the rack profile, and therefore the relaxation of the second spring, or the timer spring, is no longer blocked by the catch. This can be obtained in the second aspect of the invention by the fact that a further gearwheel is provided as a binding member between the cutouts and the gearwheel which is arranged in an axially displaceable manner. In this embodiment, by means of the actuation of the further actuating element, the gearwheel which is arranged in an axially displaceable manner is decoupled from the further gearwheel, and therefore the braking action, which acts exclusively on the displaceably arranged gearwheel, is bridged. The contact between the rotatable element and the rack profile can also be designed so as to be able to be interrupted. For this purpose, the actuating element may have, for example, a groove having a region at a right angle to an axis of rotation of the rotatable element and above or below the cutouts, and therefore, when the further actuating element is actuated, the blocked gearwheel would be offset axially into the region of the groove and therefore would no longer interact with the rack profile.

In one variant embodiment, a bridgeable mechanical catch can also be omitted, in particular if the second spring can be relaxed again manually without risk of damage.

Preferably, during the raising of the extraction product container of the second aspect, a resilient element is tensioned, said element, upon being tensioned or upon relaxing, striking a sound element and therefore triggering a signal tone. For this purpose, the device preferably has a bell which is arranged in a fixed manner relative to the base plate during the preparation and a resilient element for striking the bell, which element is arranged in a fixed manner with respect to the extraction product container. For the sake of simplicity, the resilient element is formed integrally with the guide. During the raising of the extraction product container, the projecting element describes a path in which the resilient element is located. At the same time as the raising of the extraction product container, the projecting element is guided by the guide, and therefore the projecting element comes into contact with the resilient element, and therefore the resilient element strikes the bell. By means of the resilient design, the raising of the extraction product container is not interrupted. This has the advantage that energy for the signal tone can be drawn from the first part, in particular from the larger part, of the energy accumulator.

Furthermore, the color can also be changed mechanically in one field, or the remaining period of time can be indicated via a display, similar to that of a pair of scales. The bell can also be arranged so as to be able to be struck directly by the projecting element, wherein, in this case, the bell is preferably mounted in a resilient manner. Furthermore, under some circumstances, the signaling may also be entirely omitted.

The extraction product container according to the second aspect is preferably mounted releasably on the lifting device. Simple filling and emptying of the extraction product container are therefore achieved and ergonomic cleaning of same is made possible. The extraction product container of the second aspect can have a latching-in device which retains said container in the axial direction to an extent such that, during lowering of said extraction product container, the latter is not raised out of the holder but a user can nevertheless easily withdraw said extraction product container from the holder. This may be achieved, for example, by a quarter turn fastener, a conical design of the extraction product container and a correspondingly shaped receptacle, with which a frictional connection can be achieved, a clip fastening or the like. Furthermore, the releasable mounting of the extraction product container gives rise to the possibility of using disposable inserts. The extraction product container is preferably designed so as to be able to be inserted into the lifting device.

In variant embodiments, the extraction product container is connected fixedly to the lifting device, and therefore the construction can be further simplified. However, this would have the disadvantage that the extraction product container could not be washed separately. Furthermore, the lifting device can also be integrated with the connected extraction product container in a releasable manner as a whole in the device.

The extraction product container according to the second aspect is preferably essentially designed as a cylinder which has, at least on the cylinder base, a multiplicity of holes, in particular a strainer or a net, which, in the lowered state, permit passage of the solvent. In this case, a filter insert may also be provided, and therefore fine extraction product particles which are insoluble in the solvent do not remain in the solvent or in the solvent container after the period of time has elapsed. For this purpose, in a region, an upper limit of the tolerable particle size and a lower limit of the volumetric flow through the holes are expediently optimized. To this end, furthermore, the size of the hole-having surface, the hole density (number of holes per surface unit) and the size of the holes are coordinated with one another. It is also conceivable to provide various extraction product containers which are matched to the respective extraction product. In particular, the extraction product container can be designed in two parts, comprising a holding part in the shape of a connecting pipe and a strainer part which substantially has the shape of a hollow cylinder closed on one side and which can be introduced into the holding part, and therefore it is possible for only the strainer part to be designed to be exchangeable. For example, one extraction product container, or only the strainer part, could be designed so as to be suitable for receiving a commercially available coffee filter, and another could be designed for receiving tea. For this purpose, the extraction product container can also have few openings designed with a large area for this purpose. The extraction product container may also be designed exclusively for receiving filters.

As an alternative or in addition, a nonreturn valve device for the exclusive facilitation of the admission of the solvent into the extraction product container would also be a conceivable embodiment of the extraction product container, wherein, for this purpose, either commercially available spherical nonreturn valves, or a flap which is acted upon with a spring force and is connected in an articulated manner in the interior space to the extraction product container could be used. It is also conceivable to provide the extraction product container with laterally running slots or bores. In this case, the slots can be oriented horizontally, axially or helically. Furthermore, the slots can be oriented similarly as in the case of a vegetable grater, that is to say, they can be directed in a direction of flow which is not directed counter to the axis of rotation of the extraction product container. Therefore, when the solvent flows in and out, swirling of same is achieved, and therefore rapid conducting away of the dissolved extract from the surface of the extraction product and hence efficient extraction are achieved. Such a swirling can also be produced or assisted by baffles in the interior of the extraction product container. However, this would, in turn, have the disadvantage of making the cleaning of said extraction product container difficult. The extraction product container may also be designed in a pyramid shape, as a truncated pyramid or the like.

The actuating element of the second aspect preferably comprises a cylinder barrel for receiving the extraction product container. For this purpose, the cylinder barrel has an internal diameter in the region of the external diameter of the extraction product container. Furthermore, the extraction product container preferably has a projecting edge which fixes a position of said extraction product container in the axial direction and at the same time facilitates removal of the extraction product container, wherein said removal can be further facilitated by parts on the projecting edge additionally protruding radially over the cylinder barrel. The extraction product container of the second aspect is preferably mounted in a manner secured against rotation. This can be brought about, for example, by the selection of material or by a profiling, in particular by axially designed flutes, of the surfaces in contact.

The extraction product container of the second aspect preferably consists of two parts, namely a cylinder barrel with a projecting edge and a cylindrical vessel which has, on the outside, preferably on an upper edge, a plurality of resilient parts which are preferably arranged symmetrically over the circumference of the vessel. For this purpose, the cylinder barrel has, on the inner wall, more than one, but preferably two encircling, fluted and/or profiled receptacles for the resilient parts. The effect which is therefore achieved is that the cylindrical vessel is mounted in a height-adjustable manner in the cylinder barrel. If the cylindrical vessel is pushed into the cylinder barrel, or is pulled out therefrom, the resilient parts latch into position, and therefore the cylindrical vessel is fixed axially in such a manner that it can be released from the latching and axially displaced where applicable only under increased effort, but which can be applied by an average user, and can be latched in place again in a different height setting. By means of this axially displaceable design of the cylindrical vessel, the device can be used for different solvent volumes, in particular a small solvent volume (for example approx. 0.7 L) and a large solvent volume (for example approx. 1.2 L). Therefore, in the case of a small solvent volume, the extraction product container can be pulled apart telescopically and, in the case of a large solvent volume, can be pushed together. It is therefore ensured at the corresponding volumes that, when the extraction product container is lowered, the latter is actually also immersed in the solvent, or, when the extraction product container is raised, the latter is immersed at maximum unsubstantially, if at all, in the solvent.

The cylinder barrel of the second aspect is preferably of double-walled design, and therefore the first spring can be received between the walls. The effect achieved by this is that, during the preparation of the extraction beverage, the spring is not visible and therefore a risk of injury in this regard can also be reduced.

Instead of the cylinder barrel, other receptacles are also conceivable. For example, three or more fingers could also be provided for the holding thereof.

The cylinder barrel of the second aspect preferably interacts with the first and the second spring. The extraction product container can therefore be removed or inserted or replaced irrespective of the position of the actuating element.

In variant embodiments, in particular in an embodiment with an extraction product container connected fixedly to the lifting device, the first and the second spring can also be connected directly to the extraction product container. An indirect interaction of the springs and of the cylinder barrel or of the extraction product container is, however, also conceivable.

The invention also comprises a tea kettle which has a solvent container and an attachment according to the first or the second aspect of the invention. The solvent container preferably has a teapot-like shape and therefore a more classical, round shape, since cleaning thereof is therefore simplified. A filter or a strainer for retaining undesired extraction product residues can be arranged in the transition from the teapot body to the spout. This is advantageous in particular if the extraction product container is designed to provide a more coarse filter, which, in turn, requires the extraction product to flow therethrough.

The solvent container is preferably formed from thermally stable plastic or from glass. A multiplicity of plastics, in particular from the thermosetting plastics class, are suitable for this purpose. Mention should be made for this purpose non-definitively of PF (phenolformaldehyde resins), MF/MP (melamine/melamine phenol resins), UF (urea resins), UP (unsaturated polyester resins), EP (epoxy resins), Si (silicone resins) and DAP/DIAP (diallylphthalate resins/diisoallylphthalate resins). The use of plastic for the solvent container has the advantage that production is cost-effective and simple. Furthermore, the weight of the device can thereby be kept low.

In variant embodiments, use may also be made for this purpose of different materials, such as, for example, metal alloys (for example steel, chromium steel, enamel), in particular if the solvent is intended to be heatable directly in the solvent container on a heating plate. The use of porcelain or ceramic is also conceivable.

The solvent container may also have a non-classical shape; in particular, it may, for example, have a modern or unusual shape which resembles an entirely different object. An embodiment of the solvent container with a tubular spout is also conceivable. The effect therefore achieved is that colorings and flavorings present in concentrated form in the lower part of the teapot are poured out first and possibly floating residues of the extraction product are retained. In a further embodiment, the spout may also be fitted at the top, in the region of the solvent container edge, in order to retain residues which have settled during the pouring-out operation.

Furthermore, according to the second aspect of the invention, a method for the time-controlled preparation of an extraction beverage is also provided, in which an actuating element is actuated in two different actuating directions, wherein, by means of the first actuating direction, an extraction product container is lowered into the interior space of the solvent container and also a first part of an energy accumulator is charged, and, in the second actuating direction, a period of time is predefined and the timer is activated and also a second part of the energy accumulator is charged. In principle, the actuating element can be actuated sequentially or in parallel in the two actuating directions. In the case of a sequential actuation of the actuating element, the sequence of the actuating directions can be selected freely.

The method according to the second aspect preferably runs sequentially and in steps described below: by means of the actuation of the actuating element in the second actuating direction, a period of time is predefined and the timer is activated and also a second part of the energy accumulator is charged. By means of the actuation of the actuating element in the first actuating direction, an extraction product container is lowered into the interior space of the solvent container and also a first part of an energy accumulator is charged. The actuating element is moved counter to the second actuating direction by means of a discharging of the second part of the energy accumulator during the predefined period of time. The actuating element is moved counter to the first actuating direction by means of a discharging of the first part of the energy accumulator after the predefined period of time has elapsed, and raises the solvent container out of the lowered state.

While the first and the second aspect basically show two independent ways for achieving the object according to the invention, it will be immediately clear to a person skilled in the art that various elements can advantageously be interchanged between the two aspects if they do not conflict with one another structurally. In particular, for example, the cylinder barrel of the second aspect can replace the sleeve of the first aspect. Similarly, a mounting of the extraction product container on the lifting device or the formation of the extraction product container can be interchanged between the embodiments of the two aspects without substantial modifications.

Further advantageous embodiments and combinations of features of the invention emerge from the detailed description below and the entirety of the patent claims.

### BRIEF DESCRIPTION OF THE DRAWINGS

Schematically in the drawings used for explaining the exemplary embodiment:

FIG. 1 shows a side view of a device according to the first aspect of the invention with an attachment on a solvent container, wherein the extraction product container is present in a lowered state;

FIG. 2 shows an exploded illustration of an attachment according to the first aspect of the invention;

FIG. 3 shows an oblique view of a sleeve according to the first aspect of the invention;

FIG. 4 shows an oblique view of a base plate according to the first aspect of the invention;

FIG. 5 shows an oblique view of an attachment according to the first aspect of the invention in a raised state, without dome and extraction product container, wherein only the triggering element of the timer is illustrated;

FIG. 6 shows an oblique view of an attachment according to the first aspect of the invention in a lowered state, without dome and extraction product container, wherein only the triggering element of the timer is illustrated;

FIG. 7 shows an oblique view of an attachment according to the first aspect of the invention in a raised state, without dome and sleeve, wherein only the triggering element of the timer is illustrated;

FIG. 8 shows an oblique view of an attachment according to the first aspect of the invention in a lowered state, without dome and sleeve, wherein only the triggering element of the timer is illustrated;

FIG. 9 shows a sectional illustration of an attachment according to the first aspect of the invention along a horizontal plane through the longitudinal axis of the sleeve and in the plane of symmetry of the solvent container.

FIG. 10a shows a side view of an attachment for the time-controlled preparation of an extraction beverage according to the second aspect of the invention on a solvent container with timer activated;

FIG. 10b shows a side view, opposite to FIG. 10a, of the attachment of the second aspect of the invention on a solvent container with timer not activated;

FIG. 11a shows a schematic illustration of a cross sectional plane of the attachment according to the second aspect of the invention with timer activated, the cross sectional plane running through the plane of symmetry of the solvent container;

FIG. 11b shows a schematic illustration of a cross sectional plane of the attachment according to the second aspect of the invention on a solvent container with timer not activated, the cross sectional plane running through the plane of symmetry of the solvent container;

FIG. 12 shows a schematic illustration of an oblique view of the double-walled barrel, the further actuating element, the slotted link, the bell and the torsion spring in the assembly according to the second aspect of the invention when timer is activated;

FIG. 13 shows a schematic illustration of an oblique view, opposite to FIG. 12, of the second aspect of the invention when timer is activated, wherein the first, second and the blocked gearwheel are additionally apparent;

FIG. 14 shows a schematic illustration of an oblique view of the interaction of the double-walled barrel and the slotted link according to the second aspect of the invention.

In principle, identical parts are provided with the same reference numbers in the figures.

### Ways of Implementing the Invention

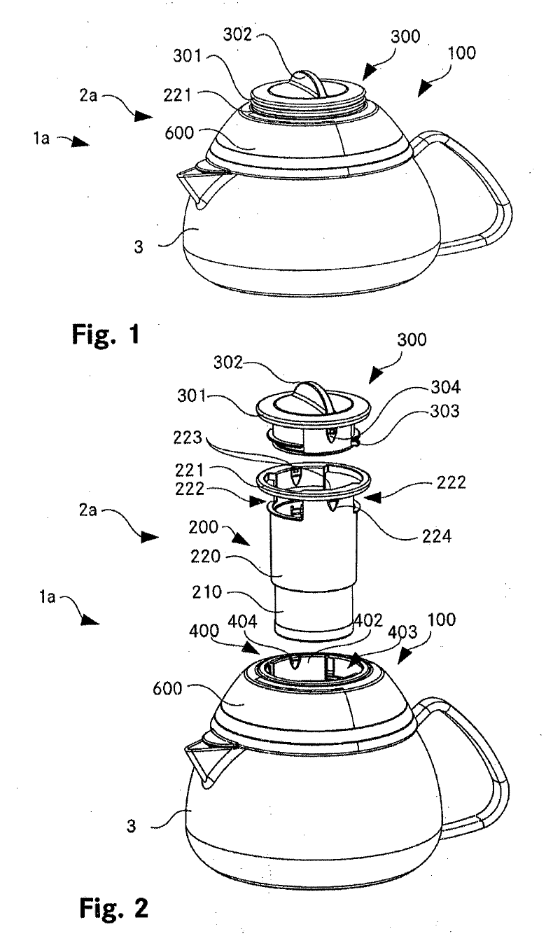

The paragraphs below describe a first embodiment according to a first aspect of the invention with reference to FIGS. 1 to 9.

FIG. 1 shows a side view of a first embodiment of a device 1a according to the invention with an attachment 2a on a solvent container 3, wherein the extraction product container 200 is present in a lowered state. The attachment 2a is connected releasably, in particular in a form-fitting manner, to the solvent container 3. In certain embodiments, an articulated connection of the attachment 2a to the solvent container 3 is also provided, which connection may also be releasable from time to time.

The attachment 2a comprises, as essential components, a main body 100 which is placed on the solvent container 3, and an extraction product container 200, wherein, of the latter, FIG. 1 only shows a flange 221 which rests on the main body. Furthermore, the attachment 2a comprises a timer 300 which is placed on the extraction product container 200 as a cover and rests with a flange 301 on the flange 221 of the extraction product container 200. The timer 300 furthermore comprises a rotary switch 302 for setting a period of time.

FIG. 2 shows, in an exploded illustration, a lateral view of the device 1a according to FIG. 1. This illustration essentially shows the components which are operated during use of the device. First of all, the extraction product container 200 is filled with extraction product, for example tea, and is subsequently introduced into the main body 100. The extraction product container 200 is closed with the timer 300. A period of time is then predefined by means of rotation of the rotary switch 302 of the timer 300. Finally, via the rotary switch 302, the extraction product container 200 is guided into the interior space of the solvent container 3. After the period of time has elapsed, the extraction product container 200 springs back such that it only partially, or no longer, projects into the interior space of the solvent container 3.

Furthermore, it is apparent in FIG. 2 that the timer 300 substantially has a cylindrical basic shape. The rotary switch 302 is mounted rotatably coaxially with respect to said basic shape. Furthermore, the timer 300 comprises a triggering element 303 which is designed in the form of two opposite pins with respect to the axis. The triggering element 303 is arranged offset axially downward with respect to the rotary switch 302 and is also mounted so as to be rotatable coaxially. The triggering element 303 projects beyond the diameter of the housing of the timer 300, but not over the flange 301 of same and describes a partial arc of a circle during the period of time. The triggering element 303 is directly coupled to the movement of the rotary switch 302; that is to say, when the period of time is set with the rotary switch 302, the triggering element 303 is pivoted by the same angle about the axis of rotation thereof.

In addition, a lug 304 can be seen below the flange 301 of the timer 300, the lug extending axially as far as the flange 301. A second such lug 304 is located on the rear side of the timer 300 (not visible).

In the present embodiment, the extraction product container 200 is formed in two parts and comprises a strainer part 210 and a holding part 220. The strainer part 210 is substantially in the shape of a hollow cylinder which is closed on one side and has a round area. The base of the strainer part 210 has holes which permit passage of solvents (not illustrated). The holding part 220 is substantially designed as a hollow cylinder which is open on two sides and has a round area and an internal diameter which corresponds to the external diameter of the strainer part 210. The strainer part 210 can be introduced telescopically into the holding part 220 and can be latched (not illustrated) in various axial positions by means of latching lugs and corresponding notchings, which may also be designed in an encircling manner. The immersion depth of the extraction product container 200 in the solvent container 3 can therefore be matched to the filling height of the solvent.

In an upper region of the inner wall, the holding part 220 has two opposite notches 223 in which, when the timer 300 is placed on, the lugs 304 can engage and thus secure the timer 300 against rotation in relation to the holding part 220. The holding part 220 furthermore has, in an upper region, a flange 221 which projects radially outward. In the upper region, the holding part 220 furthermore has two opposite apertures along a partial circle of approximately 90°, the apertures having an L-shaped cross sectional area. It is apparent from FIG. 2 that the aperture 222 only covers an inner part of the flange 221. In this region, the diameter of the holding part 220 corresponds to a diameter of the triggering element 303 of the timer 300, or to the maximum distance between the two pins of the triggering element 303. The timer 300 can be placed onto the holding part 220 in such a manner that the triggering element 303 can be guided through the corresponding apertures 222 at any period of time set, provided that the timer 300 is placed on in such a manner that the lugs 304 thereof are guided into the notches 223 of the holding part 220. This does not constitute any particular challenge for the user, since the user can rotate the timer to and fro within a range of approx. +/−45° until the timer latches in the holding part 220. The holding part has two lugs 224 on the outer wall, below the flange 221 and opposite the notches.

Finally, FIG. 2 also shows parts of the sleeve 400 which, in the present illustration, is held in the main body 100 by means of a locking device (not apparent here).

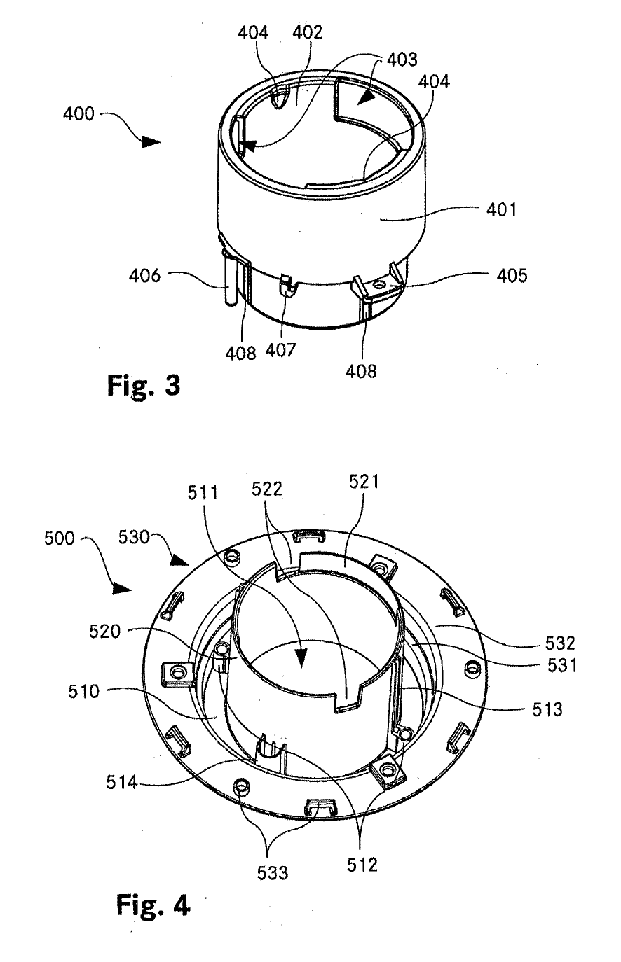

FIG. 3 shows the sleeve 400 which is substantially designed as a circular cylinder open on two sides, comprising an outer wall 401 and an inner wall 402, which define an intermediate space and are connected in an upper edge region. The inner wall 402 projects downwards beyond the outer wall 401. Furthermore, the sleeve 400 has two opposite notches 404 adjacent to the upper edge of the inside of the inner wall 402, in which notches the lugs 224 of the holding part 220 of the extraction product container 200 can engage and thus hold the latter in a manner secured against rotation. If the extraction product container 200 is then inserted into the sleeve 400, the apertures 403 of the sleeve communicate with the apertures 222 of the holding part 220, and the flange 221 of the holding part 220 comes to lie on the upper edge of the sleeve 400. Like the extraction container 200, the sleeve also has apertures 403 which have an L-shaped cross section. The upper edge is also not completely perforated here. When the timer 300 is placed on, the triggering element 303 projects through the apertures 222 and 403, in particular radially beyond the inner wall 402, but not as far as the outer wall 401. During the period of time, the radially outer ends of the triggering element 303 therefore run in the intermediate space between the inner wall 402 and the outer wall 401 of the sleeve 400.

Two sliders 405 are integrally formed in a lower region of the outer wall 401 of the sleeve 400 opposite each other with respect to the sleeve 400. The sliders 405 are designed as radially outwardly protruding elements which have an axial opening. In the region of the sliders 405, an axially oriented guide strip (not apparent) is integrally formed in each case on the inside of the outer wall 401. The purpose and the manner of operation are explained in detail further below. The outside of the inner wall 402 is also provided with four axially oriented guide rails 408 arranged in a regularly distributed manner.

Furthermore, two pins 406 which are offset radially outward with respect to the outer wall 401 and project axially downward are integrally formed on the sleeve 400 in the lower edge region of the outer wall 401. Said pins are arranged offset with respect to the sliders 405 by 90°, in approximately the same plane, at a right angle to the longitudinal axis of the sleeve 400.

Finally, two latching hooks 407 which project radially outward with respect to the outer wall 401 and are oriented substantially tangentially with respect to the sleeve 400 are integrally formed on the sleeve 400 in the lower edge region of the outer wall 401. As viewed from above, the latching hooks 407 are located below the apertures 403, in particular with respect to the clockwise direction, in a first or initial region of the respective apertures 403.

FIG. 4 shows a base plate 500 which comprises a circular plate 510 with an aperture 511, an axially arranged, upwardly projecting guide sleeve 520 communicating with the aperture 511, and a cross sectionally L-shaped flange 530 running around the outer edge of the plate 510. The guide sleeve 520 is substantially designed as a connecting pipe and is dimensioned in such a manner that the sleeve 400 can be placed onto the guide sleeve 520 such that the latter comes to lie between the outer wall 401 and the inner wall 402. In an upper region, the guide sleeve 520 inwardly has two opposite recesses 521 running around approximately 90°, or a material tapering, the recesses beginning with an aperture 522 in each case in the clockwise direction, as viewed from above. The recesses 521, or the material taperings, project as far as the upper edge of the guide sleeve 520 and have an elongate form along the circumference of the guide sleeve 520, and the apertures 522 have an approximately square shape.

Two axially oriented holding sleeves 512 which are opposite each other with respect to the guide sleeve 520 and are intended for guide rods 513 (not illustrated in FIG. 4) are arranged on the plate 510 of the base plate 500. By means of the guide rods, an axially oriented rail guide 513 is arranged in each case over the entire height between the holding sleeves 512 and the outer wall of the guide sleeve 520. When the sleeve 400 is placed on, the guide strip, which is integrally formed axially on the inside of the outer wall 401, runs in said rail guide 513, and therefore the sleeve 400 is movable in a manner secured against rotation in relation to the guide sleeve 520. Two spring guides 514 are arranged on the plate 510 in a manner offset by 90° with respect to the holding sleeves and each have an axially oriented opening.

The guide rails 408 on the outside of the inner wall 402 of the sleeve 400 serve for the low-friction guidance of the sleeve 400 on the guide sleeve 520, since the contact surface is therefore reduced. The guide is therefore overall more robust, in particular in respect of soiling.

A first flank 531 of the flange 530 is connected to the plate 510 in a manner projecting axially upward and a second flank 532 projects radially outward at the upper end of the first flank 531. A lower side of the second flank 532 forms the supporting surface for the support on a solvent container 3. The upper side of the second flank 532 is provided with a plurality of holding elements 533 for the installation of the dome-shaped covering shell 600 (see FIG. 1, 2 or 9). In order to make the figures more readable, only two of the holding elements 533 are provided with reference numbers.

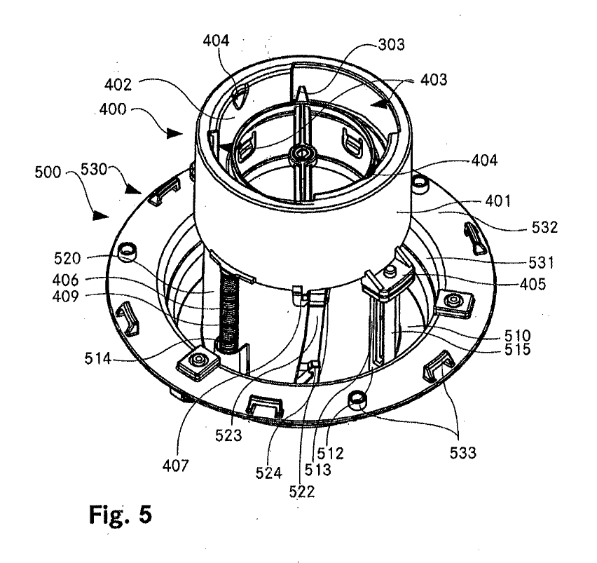

FIG. 5 shows the base plate 500 according to FIG. 4 with the sleeve 400 according to FIG. 3 placed thereon. In addition, only the triggering element 303 of the timer 300 is illustrated in the sleeve 400 in order to be able to illustrate the manner of operation of the device in a more comprehendable manner. For better clarity, the extraction product container 200 is not illustrated either. In addition to the preceding FIGS. 1 to 4, the present illustration shows a substantially relaxed spiral compression spring 409 which is arranged around the pin 406 of the sleeve 400. A lower end of the spring projects into the spring guide 514 and is thus guided by the spring guide 514 and the pin 406. The same arrangement is also found on the rear side. Furthermore, an axially oriented and upwardly projecting rod 515 which is mounted fixedly in the holding sleeve 512 can be seen. The sleeve 400 is guided linearly via the slider 405 and the rod 515. This arrangement is also found a second time on the rear side.

An actuating element 523 which is designed as a lever arm and is connected to a latching hook 524, which is arranged pivotably about a radial axis on the guide sleeve 520, can furthermore be seen. The latching hook 524 is arranged substantially horizontally above, but in the vicinity of the axis, and is spaced apart radially outward with respect to the actuating element 523. The actuating element 523 and the latching hook are acted upon with a restoring force by means of a leg spring (not illustrated) and are held in a substantially axial position. The actuating element 523 projects with an upper end in front of the aperture 522 and additionally has a lug which projects through the aperture 522. The lug serves as a contact element via which the triggering element 303 can actuate the actuating element 523.

The triggering element 303 is arranged coaxially with the sleeve 400 and substantially comprises a coaxial circular ring connected to a bar mounted centrally and rotatably, wherein the bar projects over the circular ring on two sides and thus forms contact elements for the lugs of the actuating elements 523.

The sleeve 400 is not locked, but rather is raised, in FIG. 5. The period of time has not been set, or has already elapsed. It is apparent in the present illustration that the leg spring is tensioned and, in the next moment, the actuating element 523 will spring back together with the latching hook 524 into the axial position.

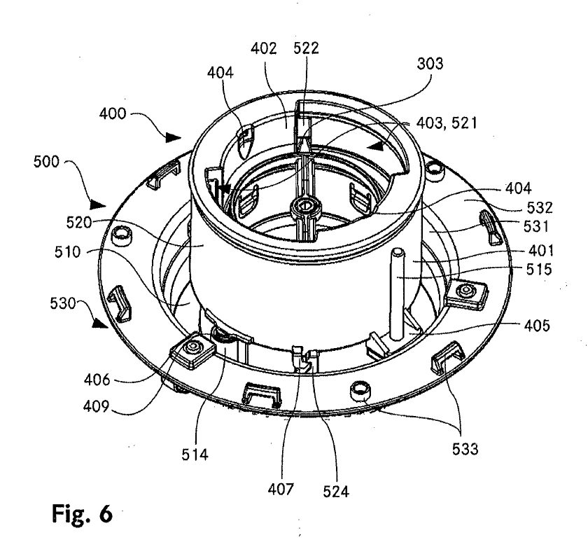

In order to activate the device, a period of time is then set with the timer 300, as a result of which the triggering element 303 is rotated to a greater or lesser degree in the clockwise direction, as seen from above, depending on the period of time. The sleeve 400 is subsequently pressed downward, and therefore the spiral compression spring 409 is tensioned and the latching hook 524 of the actuating element 523 engages over the latching hook 407 of the sleeve 400 and therefore prevents said sleeve from springing back for the time being. During the period of time, the triggering element 303 then rotates back counterclockwise until the outer ends of the triggering element 303 make contact with the lug of the actuating element. This stage is shown in FIG. 6.

FIG. 6 shows the same components as already illustrated in FIG. 5. In contrast to FIG. 5, the sleeve 400 is locked in the lowered state via the latching hook 407 of the sleeve and the latching hook 524 of the guide sleeve 520. The actuating element 523 is held in an axial orientation by the leg spring and the spiral compression spring 409 is tensioned. The triggering element 303 is already in a position corresponding to an elapsed period of time and, at the next moment, will actuate the actuating element 523 in such a manner that the same pivots counterclockwise, as seen from above, and releases the latching hook 524 from the latching hook of the sleeve. This has the result that the sleeve is moved upward by the restoring force of the spiral compression spring 409, and there the state according to FIG. 5 is reached again.

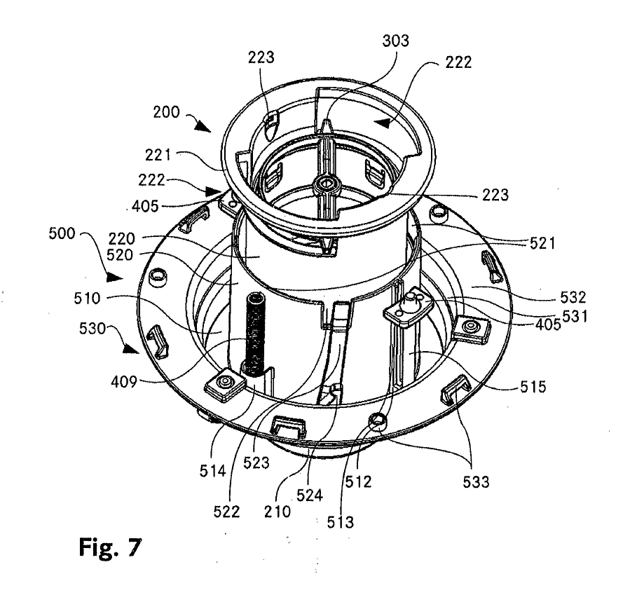

FIG. 7 shows substantially the same as FIG. 5, the sleeve 400 not being illustrated. It is apparent with reference to the triggering element 303 that, in this illustration, a maximum period of time has been set, but the extraction product container 200 has not (yet) been guided downward. The triggering element 303 has namely been rotated in the clockwise direction as far as the stop of the aperture 222 of the extraction product container 200.

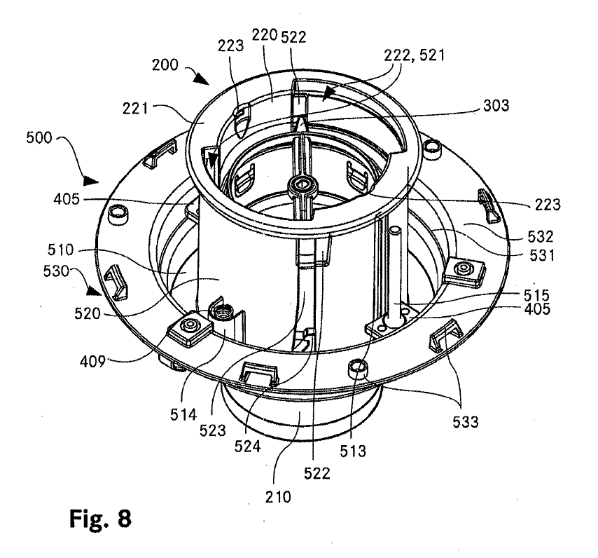

FIG. 8 in turn substantially corresponds to FIG. 6, the sleeve 400 not being illustrated. In the illustrated state, the period of time has elapsed. The triggering element 303 is already in contact with the actuating element 523, but has not yet unlocked the locking device, since the actuating element 523 is still oriented perpendicularly.

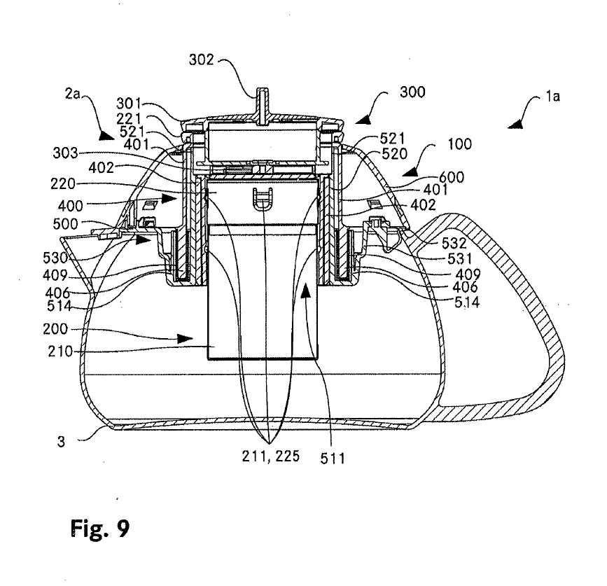

FIG. 9 shows a vertical section along a longitudinal axis through the device 1a according to FIG. 1. The extraction product container 200 is in the brewing position, i.e. has been moved downward into the interior space of the solvent container 3.

In this illustration, the telescopic construction of the extraction product container 200 is readily apparent. The strainer part 210 has circumferentially, at two heights in this embodiment, resilient knobs 211 which project radially outward. At corresponding points, the holding part 220 has depressions 225 into which the knobs 211 can latch. The strainer part 210 can therefore be pulled downward out of the holding part until the upper knobs 211 latch into the lower depressions 225.

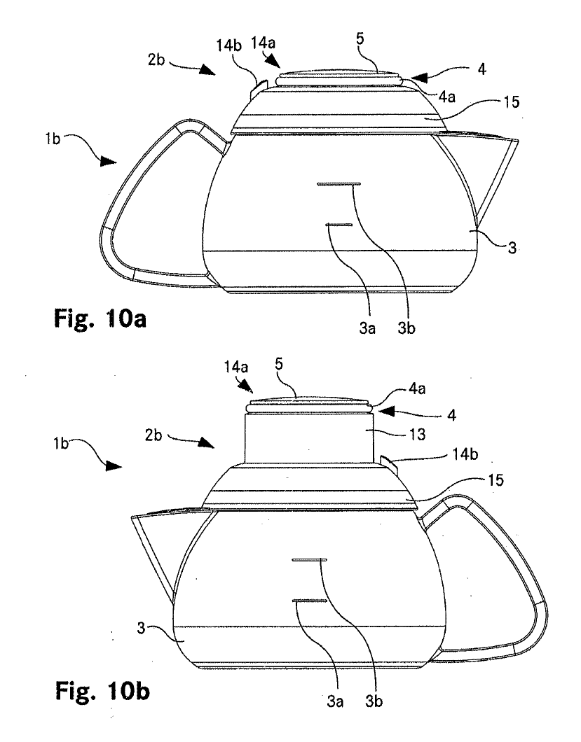

In the paragraphs below, a second embodiment according to a second aspect of the invention is described with reference to FIGS. 10 to 14.

FIG. 10a shows a side view of the device 1b according to a second aspect of the invention with timer activated. Furthermore, a second embodiment of a solvent container 3 and a matching attachment 2b can be seen. The attachment 2b is connected releasably, in particular in a form-fitting manner, to the solvent container 3. In certain embodiments, an articulated connection of the attachment 2b to the solvent container 3 is also provided, which attachment may also be releasable from time to time.

The solvent container 3 in the present embodiment consists of glass or of plastic, has a holding capacity of, for example, approximately two liters and has two markings 3a and 3b, wherein a deeper marking 3a is located at 0.7 L and a higher marking 3b at 1.2 L. However, said solvent container may also have entirely different shapes and holding capacities or be formed from different materials.

In FIG. 10b, which again shows a side view of the device 1b according to a second aspect, but from the opposite side and with timer not activated, a projection of a projecting cylinder barrel 4b of the extraction product container 4 and a cover 5 can be seen in the upper region of the attachment 2b. Finally, a second actuating element 14b and a double-walled barrel 13, which will be discussed in detail later, can be seen. The actuating element 14a is assembled here from the cover 5, the projecting cylinder barrel 4b and the double-walled barrel 13.

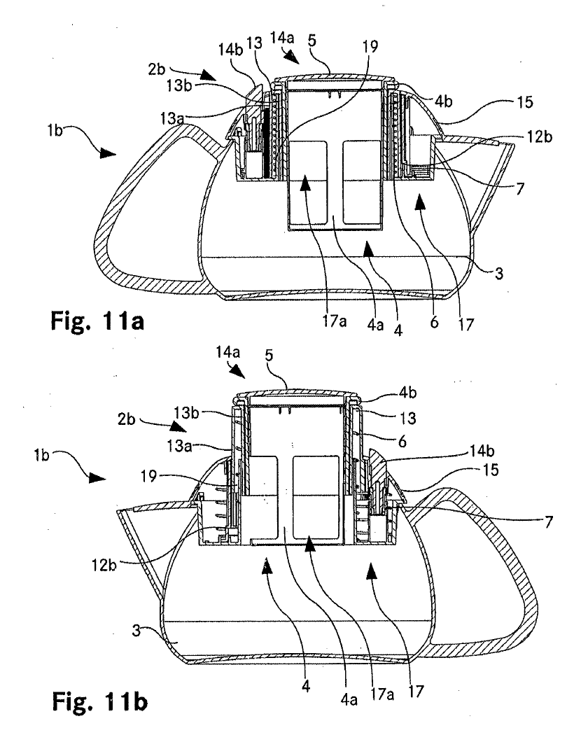

FIG. 11a illustrates a section along an axis of symmetry of the solvent container 3 through the device 1b, according to a second aspect, when timer is activated.

The double-walled barrel 13 is closed on one side and, between the two walls 13a, 13b, receives a helical spring 6, formed from spring steel, said helical spring, in a relaxed state, emerging on the open side of the double-walled barrel 13 (see in this respect FIG. 11b) and, in the tensioned state, being able to be completely accommodated by said barrel.

A base region 17 comprises a single-walled cylinder barrel 19 which encloses an opening 17a in the base region 17, said opening substantially corresponding to the cross sectional area of the extraction product container 4. The single-walled cylinder barrel 19 has an internal diameter in the region of the external diameter of the inner barrel 13b of the double-walled barrel 13, and therefore the double-walled barrel 13 can be pulled over the single-walled cylinder barrel 19. The helical spring 6 has an external diameter in the region of the internal diameter of the outer barrel 13a, and therefore the double-walled barrel 13 can also be pulled over the helical spring 6. An internal diameter of the helical spring 6 lies in the region of the external diameter of the single-walled barrel 19. Furthermore, the two barrels 13a, 13b of the double-walled barrel 13 are spaced apart in such a manner that the double-walled barrel 13 can be pulled at the same time over the single-walled cylinder barrel 19 and the helical spring 6. In this arrangement, it is now possible to tension the helical spring 6 by the double-walled barrel 13 being pressed against the base region 17. The helical spring 6 can be seen in a state completely pressed together with respect to the device 1b in FIG. 11a and in a relaxed state in FIG. 11b. As an alternative, the arrangement of the single-walled cylinder barrel 19 and of the helical spring 6 may also be interchanged such that the helical spring 6 bears against an inner wall of the single-walled cylinder barrel 19.

The extraction product container 4 is constructed to be substantially cylindrical and open on one side and has a cross sectional area in the region of the size of the opening 17a of the base region 17. In this case, the projection of the projecting cylinder barrel 4b protrudes in the region of the opening of the extraction product container 4 and can be closed by a cover 5 by means of a form-fitting and/or frictional connection. On the base and/or on the barrel in the region of the base, the extraction product container 4 has a multiplicity of openings which are formed with a large area in FIGS. 11a and 11b and are suitable for receiving filter inserts. However, said openings may also be arranged in a different manner, in particular to be smaller, or only in the base region of the extraction product container 4. The external diameter of the extraction product container 4 lies in the region of the internal diameter of the double-walled barrel 13, and therefore the extraction product container 4 can easily be introduced into the double-walled barrel 13 as far as the projection of the projecting cylinder barrel 4b, and therefore the pressing together, or tensioning of the helical spring 6 can also take place via the cover 5, or via the extraction product container 4. As a result, this charges the first part of the energy accumulator, which will raise the extraction product container 4 after the period of time has elapsed.

In the present embodiment, the extraction product container 4 is designed in two parts and comprises a cylindrical vessel 4a and a projecting cylinder barrel 4b. However, the extraction product container 4 may also be designed as a single part. In FIGS. 11a and 11b, the cylindrical vessel 4a has a plurality of openings and is designed for receiving a strainer or filter, wherein a strainer or filter may also be integrated directly in the cylindrical vessel 4a. The projecting cylinder barrel 4b has two encircling, fluted receptacles on the inner wall, and the cylindrical vessel 4a has corresponding resilient parts which protrude radially outward and, when the cylindrical vessel 4a is axially displaced in the projecting cylinder barrel 4b, latch into the fluted receptacles. The resilient elements and the fluted receptacles are matched to one another in such a manner that, by means of an axially applied force, the latched resilient elements can easily be raised out of the latching connection in order, where applicable, to latch again in the other fluted receptacle.

A torsion spring 7, again consisting of spring steel, can furthermore be seen in FIGS. 11a and 11b. The torsion spring 7 used here is in the form of a helical spring. Said spring has a negligibly small spring constant, in the axial direction, but not in the tangential direction. It is therefore not apparent in FIGS. 11a and 11b whether said spring is tensioned or is not tensioned. The torsion spring 7 is connected by a first end to the base region 17 and by an opposite end to the double-walled barrel 13 in such a manner that the torsion spring 7 is tensioned, or relaxed, upon rotation of the double-walled barrel 13. For this purpose, the double-walled barrel 13 has a tension spring holder 13d (not apparent). The second part of the energy accumulator, which part feeds the timer, is therefore charged.

In contrast to FIG. 11a, FIG. 11b illustrates a section along an axis of symmetry of the solvent container 3 through the device 1b according to a second aspect when timer is not activated, and from the opposite side. In particular, the torsion spring 7 and the extraction product container 4, which is raised by the lifting device, can be seen in FIG. 11b. In FIG. 11a, the torsion spring 7 is substantially relaxed, which, again, cannot be interpreted by the axial expansion thereof: but from the fact that the extraction product container 4 is raised.

Furthermore, a second actuating element 14b, which is discussed in more detail in the following figures, can be seen in FIG. 11b.

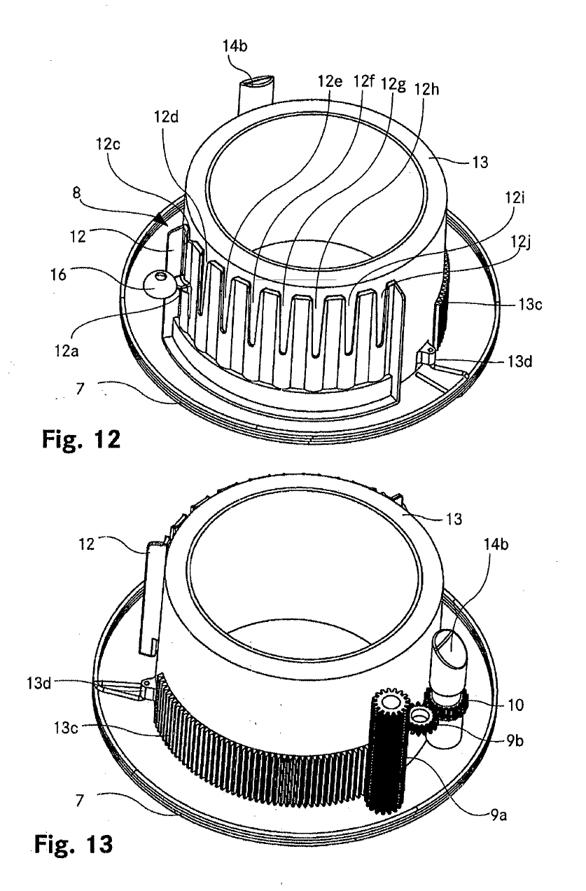

FIG. 12 shows a schematic illustration of an oblique view of the double-walled barrel 13, the second actuating element 14b, the slotted link 12, the bell 16 and the torsion spring 7 in the assembly according to a second aspect when timer is activated.

The timer according to a second aspect will be explained below with reference to FIG. 13. The double-walled barrel 13 has a protruding rack profile 13c which runs axially over a region of the outer surface of the outer barrel 13a, wherein the region has a height h oriented in the axial direction. As an alternative, the profile may also be designed in the form of flutes, or cutouts. A first gearwheel 9a engages by means of the teeth thereof in the rack profile 13c, wherein an axis of the first gearwheel 9a runs parallel to a longitudinal axis of the double-walled barrel 13 and is mounted rotatably via the base region 17 and the covering 15 (not visible here). The first gearwheel 9a has a height which lies in the region of the sum of the maximum lifting height of the extraction product container 4 and the height h. A second gearwheel 9b, which has a low height in relation to the first gearwheel 9a, interacts with the first gearwheel 9a and therefore has an axis of rotation parallel to that of the first gearwheel 9a and is mounted rotatably via the covering 15 (not visible here). The second actuating element 14b comprises a blocked gearwheel 10 which interacts with the second gearwheel 9b. The blocked gearwheel 10 is held so as to be displaceable axially, counter to a spring force, such that, when said blocked gearwheel 10 is actuated, the latter is displaced axially in such a manner that same no longer interacts with the gearwheel 9b (not visible here). The timer can therefore be interrupted, or set again to zero, by the actuation of the second actuating element 14b. For this purpose, a braking device of the blocked gearwheel 10 comprises a spindle which is connected to the blocked gearwheel 10 and is mounted in a manner blocked in silicone or an equivalent, in a bearing bush. For this purpose, the bearing bush is sealed with an O ring such that the silicone does not run out or oxidize. The mechanical catch is arranged in a thermally insulated manner in the attachment 2b in relation to the solvent container 3 such that, in the event of temperature fluctuations of the solvent, a set period of time is only slightly influenced, if at all. For this purpose, insulating material which shields the mechanical catch in the attachment 2b could also be provided (not illustrated).

A torsional spring holder 13d which is connected to the torsion spring 7 can be seen in a lower edge region of the double-walled barrel 13, wherein the other end of the torsion spring 7 is connected to the base region 17 in a manner not illustrated. If the torsion spring 7 is tensioned by rotation of the double-walled barrel 13 (second actuating direction), the blocked gearwheel 10 blocks relaxation of said spring, and therefore a rotation counter to the second actuating direction is slowed down. A time scale can be constructed via the angular velocity which the double-walled barrel 13 therefore reaches. The period of time can then be realized via an angle of rotation of the double-walled barrel 13 and is substantially proportional to the angle of rotation. If the set period of time is intended to elapse prematurely, the second actuating element 14b is actuated, and therefore the catch is decoupled and the double-walled barrel 13 rotates back in a substantially unblocked manner into a position in which the torsion spring 7 is more relaxed.

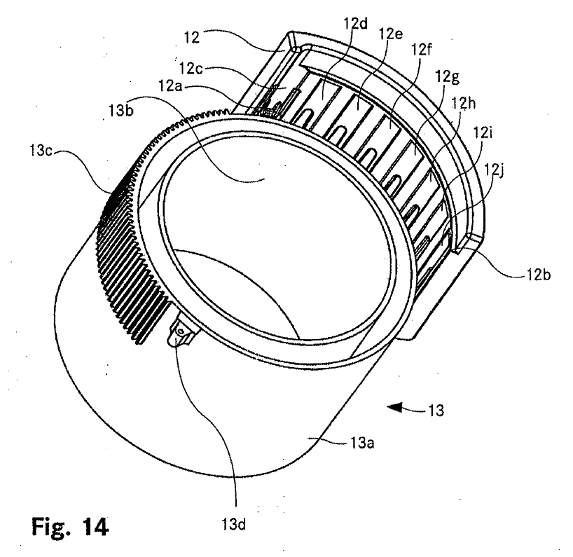

FIG. 12 shows a slotted link 12 which is substantially designed as a segment of a cylinder barrel with a radius in the region of the radius of the outer barrel 13a of the double-walled barrel 13. In this case, the area and the shape of the slotted link 12 correspond at least to the area and shape taken up by the rack profile 11. The slotted link 12 is arranged at a substantially constant, small distance, parallel to the outer barrel 13a of the double-walled barrel 13 and is connected to the base region 17. On the concave side facing the double-walled barrel 13, the slotted link 12 has, in the axial direction, a groove 12c which emerges at the bottom, in the region of the base region 17, in a step 12b which encircles the slotted link 12 on the inside (see FIG. 14). Further grooves 12d-12j, arranged parallel to the groove 12c and spaced apart from one another, have a decreasing depth in the direction of the step 12b and open out in the step 12b. Instead of forming the grooves 12d-12j with an increasing depth, the slotted link 12 may also be arranged pivoted at a corresponding angle in order to achieve the same effect.

A projecting element 8 (not visible) connected to the outer barrel 13a of the double-walled barrel 13 is guided by one of the grooves 12c-12j of the slotted link 12. The projecting element 8 may be of resilient design. The slotted link 12 may also be of resilient design. A resilient element 12a is connected to the slotted link 12 axially in the groove 12c and partially projects into the groove 12c and on the rear side projects with a region out of the slotted link 12, wherein the resilient action of said element is directed radially. A bell 16 is mounted radially in the covering 15 (not apparent) at a small distance from the region in such a manner that the projecting element 8 collides on the path thereof guided by the groove 12c with the resilient element 12a, and therefore the resilient element 12a is tensioned and thus strikes the bell 16 either during the tensioning or relaxing of the resilient element 12a.

The function of the device 1b will be described below via the chronological sequence with reference to the figures. In FIG. 11b, the timer has not (yet) been activated. The actuating element is then rotated counterclockwise in such a manner that the projecting element 8 is guided by the step 12b (FIG. 11a). The rotation tensions the torsion spring 7. Depending on the angle of rotation, the period of time is set at the same time and substantially proportionally to the angle of rotation. As an alternative, the device 1b can also be designed in such a manner that the period of time is set in the clockwise direction. The extraction product container 4 is then pressed downward, wherein the helical spring 6 is tensioned. In the meantime, the projecting element 8 is guided in one of the grooves 12c-12j of the slotted link 12, depending on the duration set, that is to say, during the lowering of the extraction product container 4, the latter is secured against rotation with respect to the solvent container 3. When the extraction product container 4 has been sufficiently lowered, the projecting element 8 snaps into the step 12b and therefore enters a region guided in the second actuating direction. In this position, the extraction product container 4 is no longer secured against rotation. Subsequently, after being released, the torsion spring 7 is relaxed in a manner blocked by the blocked gearwheel 10. In the meantime, the double-walled barrel 13 is guided by the projecting element 8 by the step 12b. After the period of time, the projecting element 8 reaches the groove 12c of the slotted link 12 and is raised in the axial direction by means of the energy stored in the helical spring 6, and therefore the extraction product container 4 is raised in the interior space of the solvent container 3. Finally, the projecting element 8 collides with the resilient element 12a and strikes the bell 16 via the region of the resilient element 12a, and therefore it is signaled to the user, in particular with regard to the extraction period of time, that the extraction beverage has been prepared and is ready.

A sequence of the method will be explained in detail below:
a) for the storage of the device 1b for the time-controlled preparation of an extraction beverage 1 (device 1b below), the extraction product container 4 is in a lowered state in order to save space. For this purpose, an additional or the above-described locking device, in particular a quarter turn fastener, is provided. For this purpose, for example, the blocked gearwheel 10 or the double-walled barrel 13 could be designed so as to be blockable with regard to rotation via the second actuating element 14b. After the device 1b has been retrieved, said locking is unlocked, and therefore the extraction product container is raised out of the solvent container.
b) the cover 5 is removed.
c) the extraction product container 4 is pulled out of the double-walled barrel 13 to the desired length (depending on the desired solvent volume) at the projecting cylinder barrel 4b.
d) the extraction product container 4 is filled with the extraction product and is inserted again into the double-walled barrel 13.
e) the solvent is poured over the extraction product. Alternatively, the attachment 12b may also be removed and the solvent poured directly into the solvent container 3.
f) the cover 5 is placed on.
g) by rotation of the actuating element 14a in the second actuating direction, counter to a force of the torsion spring 7, a desired duration is set. In this case, the projecting element 8 is latched into one of the grooves 12c-12j, for example into the groove 12e, wherein the grooves 12c-12j each correspond to a period of time.
h) the actuating element 14a is then actuated in the first actuating direction, wherein the double-walled barrel 13 is guided in the groove 12e by means of the projecting element 8. The depth of the groove 12e decreases in the first actuating direction and opens out in the step 12b, and therefore, during the actuating, the projecting element 8 snaps into the step 12b and is therefore fixed in the opposite direction, wherein the helical spring 6 presses the projecting element 8 against the step 12b.
i) subsequently, the actuating element 14a is released. During the period of time determined by the selection of the groove 12e, the actuating element 14a then rotates because of the applied force of the torsion spring 7 and is blocked by the mechanical catch counter to the second actuating direction until the mouth of the groove 12c is reached.
j) at the mouth into the groove 12c, the direction of movement of the actuating element 14a changes from the previous rotational movement into an axial movement counter to the first actuating direction, and therefore the projecting element 8 is guided through the groove 12c and is moved by the energy stored in the helical spring 6. When passing through the groove 12c, the projecting element 8 makes contact with the resilient element 12a which, in turn, strikes the bell 16 and therefore signals to the user that the extraction beverage has been prepared and is ready.
k) in order to clean the device 1b, the cover 5 can now be removed, and the extraction product container 4 lifted out and washed. Furthermore, the attachment 2b can be lifted up from the solvent container 3, and therefore the solvent container can also be washed. Subsequently, the device 1b is assembled again, the actuating element 14a is actuated in the first actuating direction and is locked by means of the quarter turn fastener (not visible) such that the device 1b can be supplied in a space-saving manner.

However, it is also possible for first of all the actuation in the first actuating direction to take place, followed by the setting of the period of time in the second actuating direction. The slotted link 12 may also be formed without the grooves 12d-12j. The period of time could therefore be set continuously. On the other hand, in the event of a preceding or simultaneous setting of the period of time, the actuation of the actuating element 14a would therefore not be guided in the first actuating direction, and therefore, in particular, a period of time set previously can be changed by a not very precise actuation of the actuating element 14a in the first actuating direction.

The extraction product containers 200, 4 and the solvent container 3 according to the two embodiments do not have to differ substantially in design; in particular, they may be of identical design. For example, the extraction product containers 200, 4 in both embodiments have a two-part form, the parts being able to be guided telescopically one in the other and latched in different axial positions. The attachments 2a, 2b may also have similarities, wherein some of the similarities, which refer, however, only to the above-described embodiments, are described below merely by way of example.

For example, an extraction product container 200, 4 is introduced in each case from above into the attachment 2a, 2b in the above-described embodiments. The extraction product container 200, 4 is fillable in each case from above, is closed with a cover 300 (timer), 5 and has a flange via which said container is held in a double-walled sleeve 400, 13. The double-walled sleeve 400, 13 is acted upon in each case with a spiral compression spring. The extraction product container 200, 4 is transferred together with the double-walled sleeve 400, 13 linearly downward, counter to a spring force of the spiral compression spring 409, 6, into the brewing position and locked there. The locking device in each case comprises an element 407, 8 which is connected fixedly to the double-walled sleeve 400, 13 and, in the locked state, interacts with an element 524, 12, which is arranged in an axially fixed manner with respect to the attachment 2a, 2b, and can thus prevent relaxation of the spiral compression spring 409, 6, or lifting of the double-walled sleeve 400, 13 and therefore of the extraction product container 200, 4. The attachment 2a, 2b comprises an element 303, 8 which rotates coaxially with respect to the extraction product container 200, 4 during the period of time, and therefore, after the period of time has elapsed, the locking device is unlocked. A period of time is set in the region of the cover 300, 5. After the period of time has elapsed, the extraction product container 200, 4 is guided linearly upward by means of the energy stored in the spiral compression spring 409, 6.

The above common features are merely by way of example and are not definitive, since common features cannot be sharply defined in this context. Further embodiments may also have more or fewer common features with one of the two embodiments; in particular, the invention is not restricted to the two embodiments.

A difference between the two embodiments of the attachment 2a, 2b consists in that, in the first embodiment, the timer is integrated in the cover 300 while, in the second embodiment, the timer is integrated in the attachment 2b.

In summary, it should be emphasized that, by means of the attachment according to the first and the second aspect of the invention, a device for the time-controlled preparation of an extraction beverage is provided, which device is simple to operate and, in addition, can be produced in a structurally simple and cost-effective manner.

1. An attachment for a solvent container for the time-controlled preparation of an extraction beverage comprising
a) a base plate for placing onto an opening of the solvent container, wherein
b) the base plate has an aperture for the passage of an extraction product container, and
c) there is a lifting device which comprises a sleeve on which the extraction product container is mounted in such a manner that it projects beyond the sleeve at a lower end and can be filled with an extraction product through an upper opening of the sleeve, wherein
d) the lifting device has a guide device which is fixed on the base plate and on which the sleeve is guided displaceably in a direction substantially perpendicular to the base plate with the effect of a linear guide between a lower and an upper position, wherein
e) the lower position defines a brewing position of the sleeve, in which the extraction product container is lowered, and the upper position defines an inoperative position in which the extraction product container is raised in relation to the brewing position, and
f) the lifting device has a locking device for locking the sleeve in the brewing position, and
g) there is a timer which is designed in such a manner for actuating the locking device that, after a predefinable period of time has elapsed, the sleeve is unlocked when it is locked in the brewing position, wherein
h) the timer comprises an actuating element for setting a period of time, wherein
i) the sleeve is acted upon along the linear guide in the brewing position by a restoring force which resets the sleeve from the brewing position into the inoperative position when the sleeve is unlocked.

2. The attachment as claimed in claim 1, wherein the restoring force is provided by an elastic element which acts between the base plate and the sleeve.

3. The attachment as claimed in either claim 1, wherein the extraction product container is insertable into the sleeve and comprises a flange as a stop on one side in an upper region.

4. The attachment as claimed in claim 1, wherein the extraction product container comprises a strainer part and a holding part, wherein the strainer part is latchable coaxially in the holding part in a plurality of axial positions.

5. The attachment as claimed in claim 1, wherein the extraction product container is lowered from above through the aperture during a transfer from the inoperative position into the brewing position of the sleeve.

6. The attachment as claimed in claim 1, wherein the sleeve is lowerable directly by a user counter to the restoring force from the inoperative position into the brewing position where the sleeve is automatically locked.

7. The attachment as claimed in claim 1, wherein all of the structural elements of the lifting device are arranged outside the sleeve with respect to the axial direction.

8. The attachment as claimed in claim 1, wherein the guide device comprises a guide sleeve which is present at the aperture on the base plate and on which the sleeve is guided displaceably, wherein an interior space of the guide sleeve communicates with the aperture of the base plate.

9. The attachment as claimed in claim 8, wherein the sleeve forms a substantially round connecting pipe.

10. The attachment as claimed in claim 9, wherein the sleeve is of double-walled design, wherein an intermediate space between the double wall is downwardly open and is upwardly substantially closed, and the sleeve is arranged pulled over the guide sleeve in such a manner that, at least in the brewing position, the guide sleeve is located in the intermediate space between the double wall.

11. The attachment as claimed in claim 1, wherein the guide device comprises guide rails which are fixed on the base plate, are arranged perpendicularly to the base plate and on which the sleeve is guided in a sliding manner by outwardly projecting, flange-like projections fixed on the sleeve.

12. The attachment as claimed in claim 1, wherein the locking device has an actuating element which is designed and arranged in such a manner that it can interact with the timer.

13. The attachment as claimed in claim 1, wherein the locking device has a first latching hook which is anchored on the base plate is arranged in such a manner that it latches with a latching element of the sleeve when the sleeve is in the brewing position.

14. The attachment as claimed in claim 13, wherein the first latching hook is acted upon with a restoring force in such a manner that the latching element of the sleeve automatically latches to the latching hook when the sleeve passes into the brewing position.

15. The attachment as claimed in claim 12, wherein the timer has a triggering element which is moved continuously during the countdown of the predefinable period of time and, after the predefinable period of time has elapsed, interacts with the actuating element of the locking device in such a manner that the sleeve is unlocked when it is locked in the brewing position.

16. The attachment as claimed in claim 12, wherein the actuating element of the locking device reaches up to an upper edge region of the sleeve when the sleeve is in the brewing position.

17. The attachment as claimed in claim 16, wherein the actuating element of the locking device reaches into a cutout in the upper edge region of the sleeve, in which cutout the triggering element of the timer is also arranged when the timer is placed onto the sleeve.

18. The attachment as claimed in claim 10, wherein the cutout is only formed on an inner wall of the sleeve.

19. The attachment as claimed in claim 1, wherein a side of the base plate, which side is provided for placing onto the solvent container, is of substantially planar design, and the opposite side of the base plate is spanned by a dome, thus producing a hollow body between the base plate and the dome, in which hollow body the components of the longitudinal guide and of the lifting device are entirely or partially accommodated.

20. The attachment as claimed in claim 1, for placing onto a solvent container, comprising:
a. a base plate for placing onto an opening of the solvent container;
b. an extraction product container;
c. a lifting device, which is attached to the base plate, for the extraction product container; wherein
d. the lifting device is designed and arranged in such a manner that the lifting device can raise the extraction product container out of a state in which it is lowered into an interior space of the solvent container when the attachment is placed onto the solvent container;
e. a locking device for locking and unlocking the lifting device in the lowered state of the extraction product container;
f. a timer which can interact with the locking device in such a manner that the lifting device is unlocked after a predefined period of time;
g. an actuating element with an actuating direction for actuating the timer; wherein
h. the timer comprises a mechanical energy accumulator for storing an actuating energy applied to the actuating element; wherein the energy accumulator is discharged during the predefined period of time;
wherein
the locking device comprises a first element and a second element, wherein, during the preparation of the extraction beverage, one element is arranged fixedly with respect to the solvent container and the other element is arranged fixedly with respect to the extraction product container, wherein the first and the second elements are arranged interacting in such a manner that the first element is guided by the second element in a second actuating direction during the predefined period of time and, after the predefined period of time has elapsed, is guided movably in a first actuating direction.

21. A tea kettle, comprising a solvent container and an attachment as claimed in claim 1.

22. Use of the attachment according to claim 1 for brewing tea.

23. The attachment as claimed in claim 2, wherein the elastic element comprises a spring.

24. The attachment as claimed in claim 23, wherein the elastic element comprises a spiral spring.

25. The attachment as claimed in claim 24, wherein the elastic element comprises a spiral compression spring.

26. The attachment as claimed in claim 8, wherein in the inoperative position, the guide sleeve at least partially receives the extraction product container.

27. The attachment as claimed in claim 13, wherein the locking device has a first latching hook which is mounted pivotably.

28. The attachment as claimed in claim 27, wherein the latching element of the sleeve comprises a second latching hook.

29. The attachment as claimed in claim 28, wherein the second latching hook is connected fixedly to the sleeve.

30. The attachment as claimed in claim 29, wherein the second latching hook is integrally formed on the sleeve,

31. The attachment as claimed in claim 30, wherein the actuating element in comprises a lever arm which is connected to the first latching hook.

32. The attachment as claimed in claim 16, wherein the timer is designed as a removable cover for the upper opening of the extraction product container.

33. The attachment as claimed in claim 17, wherein the cutout is in upwardly open such that the triggering element can be brought upward out of the cutout when the timer is removed from the sleeve.

34. The attachment as claimed in claim 18, wherein the guide sleeve has a corresponding cutout which is arranged completely overlapping with the cutout of the sleeve when the sleeve is in the brewing position.

35. The attachment as claimed in claim 19, wherein the aperture of the base plate continues through the dome such that, in the inoperative position, the sleeve projects upward out of the dome.
